(19) United States
(12) Patent Application Publication
(10) Pub. No.: US 2023/0023151 A1
(43) Pub. Date: Jan. 26, 2023

(54) PRODUCTION OF SUPPLEMENTARY CEMENTITIOUS MATERIALS THROUGH SEMI-WET CARBONATION, CYCLIC CARBONATION, NON-SLURRY CARBONATION, HIGH TEMPERATURE CARBONATION AND GRANULATION CARBONATION

(71) Applicant: Solidia Technologies, Inc., Piscataway, NJ (US)

(72) Inventors: Vahit Atakan, West Windsor, NJ (US); Ahmet Cuneyt Tas, Piscataway, NJ (US); Mario Jorge Davidson, Somerset, NJ (US); Xudong Hu, Monroe, NJ (US); Sadananda Sahu, Tallahassee, FL (US)

(21) Appl. No.: 17/855,576

(22) Filed: Jun. 30, 2022

Related U.S. Application Data
(60) Provisional application No. 63/217,590, filed on Jul. 1, 2021.

(51) Int. Cl. C04B 7/36; C04B 7/40; C04B 7/51; C04B 7/52

(52) U.S. Cl. CPC C04B 7/367; C04B 7/40; C04B 7/51; C04B 7/527; C04B 2111/00017

(57) ABSTRACT

Methods for preparing a carbonated supplementary cementitious materials, including semi-wet carbonation, cyclic carbonation, non-slurry carbonation, high temperature carbonation and/or granular carbonation of a carbonatable material.

### CROSS-REFERENCE TO RELATED APPLICATION

This application claims the benefit of priority pursuant to 35 U.S.C. § 119(e) to U.S. provisional Application No. 63/217,590, filed Jul. 1, 2021, the entire contents of which are incorporated by reference as if fully set forth herein.

### FIELD

The present application is directed to the preparation of carbonated supplementary cementitious materials using various carbonation methods, including a semi-wet carbonation method, a cyclic carbonation method, a non-slurry carbonation method and a high temperature carbonation method.

### BACKGROUND

In this specification where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

The production of ordinary Portland cement (OPC) is a very energy-intensive process and a major contributor to greenhouse gas emissions. The cement sector is the third largest industrial energy consumer and the second largest CO₂ emitter of total industrial CO₂ emissions. World cement production reached 4.1 Gt in 2019 and is estimated to contribute about 8% of total anthropogenic CO₂ emissions.

In an attempt to combat climate change, the members of the United Nations Framework Convention on Climate Change (UNFCC), through the Paris Agreement adopted in December 2015, agreed to reduce CO₂ emissions by 20% to 25% in 2030. This represents an annual reduction of 1 giga ton CO₂. Under this agreement, the UNFCC agreed to keep the global temperature rise within 2° C. by the end of this century. To achieve this goal, the World Business Council for Sustainable Development (WBCSD) Cement Sustainability Initiative (CSI) developed a roadmap called “Low-Carbon Transition in Cement Industry” (WBCSD-CSI). This roadmap identified four carbon emissions reduction levers for the global cement industry. The first lever is improving energy efficiency by retrofitting existing facilities to improve energy performance. The second is switching to alternative fuels that are less carbon intensive. For example, biomass and waste materials can be used in cement kilns to offset the consumption of carbon-intensive fossil fuels. Third is reduction of clinker factor or the clinker to cement ratio. Lastly, the WBCSD-CSI suggests using emerging and innovative technologies such as integrating carbon capture into the cement manufacturing process.

Thus, there is a need for improved cement production that reduces CO₂ emissions; and, therefore, reduces the global effect of climate change. The present disclosure attempts to address these problems, as identified by the EPA and the UNFCCC, by developing a method of integrating carbon capture into the cement manufacturing process.

For instance, Solidia Technologies Inc. has developed a low CO₂ emissions clinker that reduces CO₂ emissions by 30%. However, a need exists to integrate such materials into conventional hydraulic concrete materials in order to reduce the clinker factor in hydraulic cements such as ordinary Portland cement (OPC), and to further boost the positive environmental potential through the use of such low CO₂ emissions materials as supplementary cementitious materials (SCM) in concrete. While certain aspects of conventional technologies have been discussed to facilitate disclosure of the invention, Applicant in no way disclaims these technical aspects, and it is contemplated that the claimed invention may encompass or include one or more of the conventional technical aspects discussed herein.

### SUMMARY

It has been discovered that the above-noted deficiencies can be addressed, and certain advantages attained, by the present invention. For example, the methods, and compositions of the present invention provide a novel approach to pre-carbonate a carbonatable clinker, preferably but not exclusively a low CO₂ emission clinker, before adding it to a hydraulic cement as a supplementary cementitious material (SCM), thereby both reducing the clinker factor of conventional hydraulic cements, and incorporating carbon capture into the production of the cement or concrete material, thus providing a doubly positive environmental benefit. Various exemplary methods for preparing the SCM includes a semi-wet carbonation process, a cyclic carbonation process, a non-slurry carbonation process and a high temperature carbonation process.

It should be understood that the various individual aspects and features of the present invention described herein can be combined with any one or more individual aspect or feature, in any number, to form embodiments of the present invention that are specifically contemplated and encompassed by the present invention. Furthermore, any of the features recited in the claims can be combined with any of the other features recited in the claims, in any number or in any combination thereof. Such combinations are also expressly contemplated as being encompassed by the present invention.

According to an exemplary embodiment, the present invention provides a method of preparing a carbonated supplementary cementitious material, including: adding water to a carbonatable material to form a semi-wet mixture, wherein a moisture content of the semi-wet mixture is from about 0.1% by mass to about 20% by mass based on the total mass of the semi-wet mixture; agitating or stirring the semi-wet mixture for about 0.01 hours to about 72 hours; and carbonating the wet mixture to obtain the carbonated cementitious material. The process of carbonating the semi-wet mixture comprises a plurality of carbonation cycles, and each of the plurality of carbonation cycles comprises flowing a gas comprising carbon dioxide into the wet mixture and maintaining a temperature of about 1° C. to about 99° C.

According to another exemplary embodiment, the present invention provides a method of preparing a carbonated supplementary cementitious material, including: a plurality of drying cycles comprising heating a carbonatable material to a predetermined temperature; a plurality of wetting cycles comprising introducing water to the heated carbonatable material; and carbonating the carbonatable material to obtain the carbonated supplementary cementitious material. The process of carbonating the carbonatable material includes flowing a gas comprising carbon dioxide into the carbonatable material.

According to another exemplary embodiment, the present invention provides a method of preparing a carbonated supplementary cementitious material, including: mixing a carbonatable material with a pre-heated liquid; and carbonating the carbonatable material to obtain the carbonated supplementary cementitious material. The process of carbonating the carbonatable material includes flowing a gas comprising carbon dioxide into the carbonatable material for about 0.01 hours to about 72 hours and maintaining a temperature of about 1° C. to about 99° C., and is carried out in a high humidity chamber.

According to another exemplary embodiment, the present invention provides a method of preparing a carbonated supplementary cementitious material, including: introducing a carbonatable material to a reactor; and carbonating the carbonatable material to obtain the carbonated supplementary cementitious material. The process of carbonating the carbonatable material includes flowing a gas comprising carbon dioxide into the carbonatable material for about 0.01 hours to about 72 hours while agitating or stirring and maintaining a temperature of about 200° C. to about 700° C. to obtain the carbonated supplementary cementitious material.

According to another exemplary embodiment, the present invention provides method of preparing a carbonated supplementary cementitious material, including: granulating a carbonatable material to form carbonatable material granules; and carbonating the carbonatable material granules. The process of carbonating the carbonatable material granules includes: flowing a gas comprising carbon dioxide into the carbonatable material granules for about 0.01 hours to about 72 hours while agitating or stirring and maintaining a temperature of about 1° C. to about 99° C. to obtain the carbonated supplementary cementitious material.

### BRIEF DESCRIPTION OF THE DRAWINGS

These and other features of this invention will now be described with reference to the drawings of certain embodiments which are intended to illustrate and not to limit the invention.

FIG. 1 is an image of a carbonation set up for a semi-wet carbonation process according to an exemplary embodiment.

FIG. 2 is a graphical representation of the carbonation and temperature profiles of a carbonation chamber during a semi-wet carbonation process according to an exemplary embodiment.

FIG. 3 is a graphical representation of the mass of CO₂ uptake as a function of reaction time for a semi-wet carbonation process according to an exemplary embodiment.

FIG. 4 is graphical representation of the particle size distribution, after grinding and sieving, of the supplementary cementitious material (SCM), prepared using a semi-wet carbonation process according to an exemplary embodiment.

FIG. 5 is a plot of the compressive strength of ordinary Portland cement (OPC) and a mixture of OPC and carbonated SCM and the strength activity index (SAI) of the mixture of OPC and SCM, where the SCM is prepared using a semi-wet carbonation process according to an exemplary embodiment.

FIG. 6 is a graphical representation of the ASTM standard test method for determining potential alkali-silica reactivity (ASR) of 100% ordinary Portland cement and a mixture of ordinary Portland cement and a carbonated supplementary cementitious materials, according to an exemplary embodiment.

FIG. 7 is a graphical representation of a percentage mass gain after carbonation of a Solidia Cement™ (WH16-G2) and a mixture of 2 wt % MgO and 98 wt % Solidia Cement™ (WH16-G3).

FIG. 8 is a graphical representation of a percentage mass gain after carbonation of Solidia Cement™ (WH16-G2) and a mixture of 2 wt % MgO+98 wt % Solidia Cement™ (WH16-G3) and 5 wt % acetic acid solution, according to an exemplary embodiment.

FIGS. 9A to 9D are scanning electron microscopy (SEM) images of carbonated supplementary cementitious materials after carbonation for 1 hour using a carbonation process that includes a mixture of Solidia Cement™ (WH16-G2) and 2 wt % MgO+98 wt % Solidia Cement™ (WH16-G3) and 5 wt % acetic acid solution, according to an exemplary embodiment.

FIGS. 10A to 10D are SEM images of carbonated supplementary cementitious materials after carbonation for 2 hours using a carbonation process that includes Solidia Cement™ (WH16-G2) and a mixture of 2 wt % MgO+98 wt % Solidia Cement™ (WH16-G3) and 5 wt % acetic acid solution, according to an exemplary embodiment.

FIGS. 11A to 11D are SEM images of carbonated supplementary cementitious materials after carbonation for 5 hours using a carbonation process that includes Solidia Cement™ (WH16-G2) and a mixture of 2 wt % MgO+98 wt % Solidia Cement™ (WH16-G3) and 5 wt % acetic acid solution, according to an exemplary embodiment.

FIGS. 12A to 12D are SEM images of carbonated supplementary cementitious materials after carbonation for 1 hour using a carbonation process that includes Solidia Cement™ (WH16-G2) and a mixture of 2 wt % MgO+98 wt % Solidia Cement™ (WH16-G3) and 5 wt % acetic acid solution, with citric acid pre-mixed in the solution, according to an exemplary embodiment.

FIGS. 13A to 13D are SEM images of carbonated supplementary cementitious materials after carbonation for 2 hours using a carbonation process that includes Solidia Cement™ (WH16-G2) and a mixture of 2 wt % MgO+98 wt % Solidia Cement™ (WH16-G3) and 5 wt % acetic acid, with a low does citric acid pre-mixed in the solution, according to an exemplary embodiment.

FIGS. 14A to 14D are SEM images of carbonated supplementary cementitious materials after carbonation for 5 hours using a carbonation process that includes Solidia Cement™ (WH16-G2) and a mixture of 2 wt % MgO+98 wt % Solidia Cement™ (WH16-G3) and 5 wt % acetic acid solution, with citric acid pre-mixed in the solution, according to an exemplary embodiment.

FIG. 15 is a graphical representation of the weight % CO₂ in the sample with increasing carbonation time for a carbonation process using 2 wt % MgO+98 wt % Solidia Cement™ and 5 wt % acetic acid according to an exemplary embodiment.

FIG. 16 is a graphical representation of the weight % CO₂ in the sample with increasing carbonation time for a carbonation process using 2 wt % MgO+98 wt % Solidia Cement™ and 5 wt % acetic acid, with a low dose of citric acid pre-mixed in the solution, according to an exemplary embodiment.

FIGS. 17A to 17D are SEM images of carbonated supplementary cementitious materials after carbonation for 5 hours using a carbonation process that includes Solidia Cement™ (WH16-G2) and a mixture of 2 wt % MgO+98 wt % Solidia Cement™ WH16-G3) and 2 wt % acetic acid, with a small dose of pre-dissolved citric acid, according to an exemplary embodiment.

FIG. 18 is an illustration of an exemplary fluidized bed reactor.

FIGS. 19A to 19E are SEM images of granulated carbonatable material prior to the carbonation process, according to an exemplary embodiment.

FIGS. 20A to 20F are SEM images of granulated carbonatable material after the carbonation process has been completed, according to an exemplary embodiment.

FIGS. 21A to 21E are SEM images of granulated carbonatable material prior to the carbonation process according to an exemplary embodiment.

FIGS. 22A to 22F are SEM images of granulated carbonatable material after the carbonation process has been completed, according to an exemplary embodiment.

FIGS. 23A to 23F are SEM images of granulated carbonatable material prior to the carbonation process according to an exemplary embodiment.

FIGS. 24A to 24F are SEM images of granulated carbonatable material after the carbonation process has been completed, according to an exemplary embodiment.

FIG. 25 is a graphical representation of the thermogravimetric analysis (TGA) data of granulated carbonatable material, according to various exemplary embodiments.

FIGS. 26A to 28C are SEM images of the microstructure of the carbonated SCM after carbonation slurry, with and without admixture of carboxylic acid additive (FIGS. 26A to 26C), which includes MgO, a low-dose of Glenium-7500™ water-reducer and a low dosage of citric acid (FIGS. 27A to 27C), and which includes MgO, but does not include a water-reducer and does not include citric acid (FIGS. 28A to 28C).

FIGS. 29A to 29F are SEM images showing the change in CaCO₃ polymorph microstructure based on a change in the CO₂ feeding rate.

### DETAILED DESCRIPTION

Further aspects, features and advantages of this invention will become apparent from the detailed description which follows.

As used herein, the singular forms “a”, “an” and “the” are intended to include the plural forms as well, unless the context clearly indicates otherwise. Additionally, the use of “or” is intended to include “and/or”, unless the context clearly indicates otherwise.

As used herein, “about” is a term of approximation and is intended to include minor variations in the literally stated amounts, as would be understood by those skilled in the art. Such variations include, for example, standard deviations associated with techniques commonly used to measure the amounts of the constituent elements or components of an alloy or composite material, or other properties and characteristics. All of the values characterized by the above-described modifier “about,” are also intended to include the exact numerical values disclosed herein. Moreover, all ranges include the upper and lower limits.

Any compositions described herein are intended to encompass compositions which consist of, consist essentially of, as well as comprise, the various constituents identified herein, unless explicitly indicated to the contrary.

As used herein, the recitation of a numerical range for a variable is intended to convey that the variable can be equal to any value(s) within that range, as well as any and all sub-ranges encompassed by the broader range. Thus, the variable can be equal to any integer value or values within the numerical range, including the end-points of the range. As an example, a variable which is described as having values between 0 and 10, can be 0, 4, 2-6, 2.75, 3.19-4.47, etc.

In the specification and claims, the singular forms include plural referents unless the context clearly dictates otherwise. As used herein, unless specifically indicated otherwise, the word “or” is used in the “inclusive” sense of “and/or” and not the “exclusive” sense of “either/or.”

Unless indicated otherwise, each will of the individual features or embodiments of the present specification are combinable with any other individual feature or embodiment that are described herein, without limitation. Such combinations are specifically contemplated as being within the scope of the present invention, regardless of whether they are explicitly described as a combination herein.

Technical and scientific terms used herein have the meaning commonly understood by one of skill in the art to which the present description pertains, unless otherwise defined. Reference is made herein to various methodologies and materials known to those of skill in the art.

As used herein, “semi-wet” is intended to include a state of being partially wet, and “semi-wet material” is intended to include any material that is partially wet, and such a material may include a moisture content in an amount of from about 0.1% to about 99.99% by mass based on the total mass of the semi-wet material, preferably from about 0.1% to about 50%, and more preferably from about 0.1% to about 20%, and having any values falling within any of these enumerated ranges, such as 0.1%, 1.0%, 0.5% to 10%, 10.5%, 6.75% to 9.25%, by mass based on the total mass of the semi-wet material, and the like. The value of the moisture content can be equal to any integer value or values within any of the above-described numerical ranges, including the end-points of the range.

As used herein, “short duration” is intended to include a time of 30 seconds or more and 10 minutes or less, 40 secs to 10 minutes, 50 seconds to 9 minutes, 60 seconds to 8 minutes, 2 minutes to 7 minutes, 3 minutes to 6 minutes, 4 minutes, 5 minutes, and the like. The value of the “short duration” can be equal to any integer value or values within any of the above-described numerical ranges, including the end-points of the range.

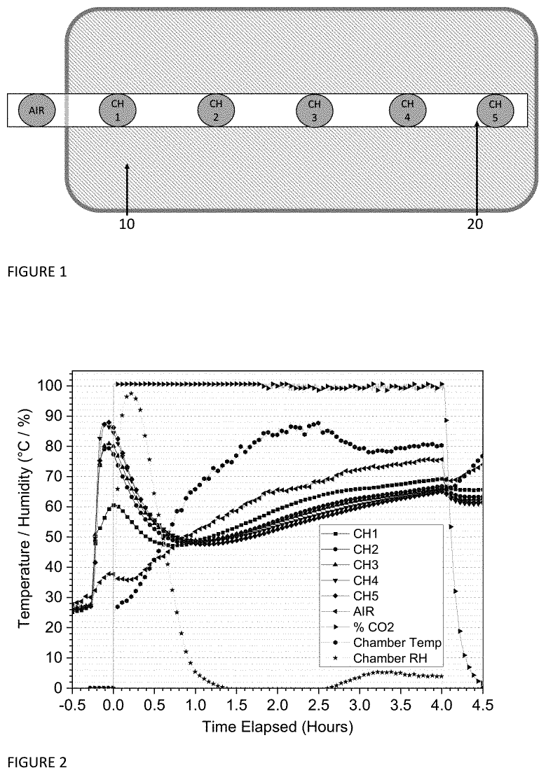

FIG. 1 is an image of a carbonation set up for a semi-wet carbonation process according to an exemplary embodiment. As illustrated in FIG. 1, the carbonation set up can include a tray 10 filled with a bed of moist carbonatable powder, and a thermocouple strip 20, which is covered by the bed of moist carbonatable powder. An exemplary setup also includes powder temperature measurement channels 1 to 5, which are labeled as CH1-CH5 in FIG. 1, but the carbonation set up is not limited thereto, and any number of channels may be used to control process conditions.

The base material used to form the supplementary cementitious materials of the present invention is not particularly limited so long as it is carbonatable. As used herein, the term “carbonatable” means a material that can react with and sequester carbon dioxide under the conditions described herein, or comparable conditions. The carbonatable material can be a naturally occurring material, or may synthesized from precursor materials.

An exemplary embodiment is directed to a method of preparing a carbonated supplementary cementitious material, the method comprising: adding water to a carbonatable material to form a semi-wet mixture, wherein a moisture content of the semi-wet mixture is from about 0.1% to about 20% by mass based on the total mass of the semi-wet mixture; agitating or stirring the semi-wet mixture for about 0.01 hour to 72 hours; and carbonating the semi-wet mixture to obtain the carbonated cementitious material, wherein carbonating the wet mixture comprises a plurality of carbonation cycles, and wherein each of the plurality of carbonation cycles comprises flowing a gas comprising carbon dioxide into the semi-wet mixture and maintaining a temperature of about 1° C. to about 99° C.

The moisture content of the semi-wet mixture may be from about 5% to about 15%, from about 6% to about 12%, from about 7% to about 10%, from about 8% to about 10%, preferably be about 9%, by mass based on the total mass of the semi-wet mixture, and the like. The moisture content can be equal to any integer value or values within any of the above-described numerical ranges, including the end-points of these ranges.

The semi-wet mixture may be agitated or stirred for about 5 hours to about 15 hours, for about 5.5 hours to about 14 hours, for about 6 hours to about 13 hours, from about 6.5 hours to about 12 hours, from about 7 hours to about 11 hours, from about 7.5 hours to about 10 hours, and the like. The time of agitating or stirring can be equal to any integer value or values within any of the above-described numerical ranges, including the end-points of these ranges.

The order of the various steps of the above-described method is not particularly limited, and the agitating or stirring and the carbonating may be carried out simultaneously or the agitating or stirring and the carbonating may be carried out successively.

In another exemplary embodiment, the process may further comprise: drying the carbonated supplementary cementitious material for about 5 to about 25 hours, for about 5 hours to about 24 hours, for about 6 hours to about 24 hours, and the like, at a temperature of about 50° C. to about 150° C., about 53° C. to about 140° C., about 56° C. to about 130° C., about 60° C. to about 120° C., and the like; and/or spreading out the semi-wet mixture in a layer having a thickness of 1 inch or less prior to exposing the semi-wet mixture to a carbonation cycle; and/or de-agglomerating the wet mixture; and/or re-wetting and agitating or stirring the semi-wet mixture after each of the plurality of carbonation cycles; and/or a plurality of milling cycles of the carbonated supplementary cementitious material; and/or moistening the gas comprising carbon dioxide prior to feeding the gas during the plurality of carbonation cycles, wherein moistening the gas comprises bubbling the gas through hot water. The values of the above-described numerical ranges can be equal to any integer value or values within any of the above-described numerical ranges, including the end-points of these ranges. The deagglomeration process can occur in between or during any of the process steps described herein, including but not limited to the steps of wetting, drying, carbonation, and the like.

Each of the plurality of milling cycles may be carried out for about 5 minutes to about 180 minutes; for about 30 minutes to about 150 minutes; for about 60 minutes to about 120 minutes; for about 75 minutes to about 105 minutes, preferably about 90 minutes, and the like. The time of each of the plurality of milling cycles can be equal to any integer value or values within any of the above-described numerical ranges, including the end-points of these ranges.

A mean particle size (d50) of the carbonated supplementary cementitious cement after completion of the plurality of milling cycles may be from about 5 μm to about 25 μm, from about 6 μm to about 24 μm, from about 7 μm to about 23 μm, from about 8 μm to about 22 μm, from about 9 μm to about 21 μm, from about 10 μm to about 20 μm, and the like. The mean particle size (d50) can be equal to any integer value or values within any of the above-described numerical ranges, including the end-points of these ranges. The mean particle size (d50) was measured using a laser diffraction particle sizing method.

A total time for the plurality of carbonation cycles is from about 1 minute to about 150 hours, from about 5 minutes to about 149 hours, from about 10 minutes to about 148 hours, from about 20 minutes to about 147 hours, from about 30 minutes to about 145 hours, from about 1 hour to about 140 hours, from about 1.5 hours to about 130 hours, from about 2 hours to about 120 hours, from about 3 hours to about 110 hours, from about 3.5 hours to about 100 hours, from about 4 hours to about 96 hours, and the like. The total time can be equal to any integer value or values within any of the above-described numerical ranges, including the end-points of these ranges.

The gas used for carbonation may comprise about 5% by volume to about 100% by volume of carbon dioxide based on the total volume of the gas used for carbonation, from about 20% to about 100%, from about 30% to about 100%, from about 40% to about 100%, from about 50% to about 100%, from about 60% to about 100%, from about 70% to about 100%, from about 80% to about 100%, from about 90% to about 100%, by volume, based on the total volume of the gas used for carbonation. The carbon dioxide content can be equal to any integer value or values within any of these ranges, including the end-points of these ranges.

The gas comprising carbon dioxide may be obtained from a flue gas. However, the gas comprising carbon dioxide is not limited thereto and any suitable source of gas containing carbon dioxide can be used. For example, a number of suppliers of industrial gases offer tanked carbon dioxide gas, compressed carbon dioxide gas and liquid carbon dioxide, in a variety of purities. Alternatively, the carbon dioxide can be recovered as a byproduct from any suitable industrial process. As used herein, a source of carbon dioxide from the byproduct of an industrial process will be generally referred to as “flue gas.” The flue gas may optionally be subject to further processing, such as purification, before being introduced into the slurry, semi-wet. By way of non-limiting examples, the carbon dioxide can be recovered from a cement plant, power plant, etc.

A flow rate of the gas comprising carbon dioxide is from about 1 L/min to about 10 L/min, from about 1.5 L/min to about 9 L/min, from about 2 L/min to about 8 L/min, from about 2.5 L/min to about 7 L/min, from about 3 L/min to about 6 L/min, per kilogram of carbonatable material. The flow rate can be equal to any integer value or values within any of these ranges, including the end-points of these ranges.

The comprising carbon dioxide may be flowed in the plurality of carbonation cycles for about 0.01 hours to about 72 hours, for about 0.05 hours to about 70 hours, for about 0.1 hour to about 65 hours, about 0.2 hours to about 60 hours, about 0.3 hours to about 55 hours, about 0.4 hours to about 50 hours, about 0.5 hours to about 45 hours, about 0.6 hours to about 40 hours, about 0.7 hours to about 35 hours, about 0.8 hours to about 30 hours, for about 0.9 hours to about 25 hours, for about 1 hour to about 20 hours, for about 2 hours to about 15 hours, for about 5 hours to about 10 hours, for about 4 hours to about 6 hours, and the like. The time of flowing the gas can be equal to any integer value or values within any of these ranges, including the end-points of these ranges.

The gas comprising carbon dioxide may be flowed over the carbonatable material at a temperature of about 1° C. to about 99° C., about 5° C. to about 90° C., about 10° C. to about 85° C., about 20° C. to about 80° C., about 30° C. to about 70° C., and the like. The temperature can be equal to any integer value or values within any of these ranges, including the end-points of these ranges.

All carbonation cycles are exothermic reactions.

The order of the various steps of the above-described method is not particularly limited, and the plurality of milling cycles may be carried out concurrently with the plurality of carbonation cycles or the plurality of milling cycles and the plurality of carbonation cycles may be carried out sequentially.

One or more additives may be added to the carbonatable material, such as: a dispersing agent such as polycarboxylate ether (PCE), sugars, etc.; set retarding agents such as sugars, citric acids and its salts; carbonation enhancing additives such as acetic acid and its salts, vinegar etc.

The plurality of milling cycles is carried out in a ball mill, a vertical roller mill, a belt roller mill, a granulator, a hammer mill, a milling roller, a peeling roller mill, an air-swept roller mill, or a combination thereof, but the apparatus is not limited thereto, and any suitable apparatus may be used in the plurality of milling cycles.

Another exemplary embodiment is directed to a method of preparing a carbonated supplementary cementitious material, the method comprising: a plurality of drying cycles comprising heating a carbonatable material to a predetermined temperature; a plurality of wetting cycles comprising introducing water to the heated carbonatable material; and carbonating the carbonatable material to obtain the carbonated supplementary cementitious material, wherein the carbonating comprises flowing a gas comprising carbon dioxide into the carbonatable material.

The predetermined temperature of the carbonatable material may be about 50° C. to about 150° C., about 55° C. to about 145° C., about 60° C. to about 140° C., about 65° C. to about 130° C., about 70° C. to about 120° C., about 75° C. to about 125° C., about 85° C. to about 115° C., and the like. The temperature can be equal to any integer value or values within any of these ranges, including the end-points of these ranges.

A starting liquid to solid (L/S) ratio of a mixture comprising the carbonatable material and water may be about 0.01 to about 0.5, about 0.02 to about 0.20, about 0.05 to about 0.15, about 0.07 to about 0.10, preferably about 0.08, and the like. The L/S ratio can be equal to any integer value or values within any of these ranges, including the end-points of these ranges.

A total time for the plurality of drying cycles may be about 1 hour to about 15 hours, about 2 hours to about 10 hours, about 3 hours to about 8 hours, hours, and the like. The total time can be equal to any integer value or values within any of these ranges, including the end-points of these ranges.

Each of the plurality of wetting cycles may be of a shorter duration than each of the plurality of drying cycles, but is not limited thereto.

A duration of each of the wetting cycles may be from about 1 minute to about 60 minutes; from about 1 minute to about 30 minutes, from about 5 minutes to about 20 minutes, and the like. The duration can be equal to any integer value or values within any of these ranges, including the end-points of these ranges.

A duration of each of the drying cycles may be from about 1 minute to about 60 minutes, from about 1 minute to about 30 minutes, from about 5 minutes to about 20 minutes, and the like. The duration can be equal to any integer value or values within any of these ranges, including the end-points of these ranges.

The order in which the various steps are carried out is not particularly limited and the carbonation of the carbonatable material to form the supplementary cementitious material may be carried out between each of the plurality of wetting cycles or may be carried out concurrently with the plurality of wetting cycles.

In each of the plurality of wetting cycles, the water is introduced to the heated carbonatable method by flooding the heated carbonatable material with the water, introducing the water to the heated carbonatable material through an aerosol nozzle to control a droplet size of the water, introducing the water to the heated carbonatable material intermittently, submerging the heated carbonatable material in the water, covering a part or an entirety of an exposed top surface of the heated carbonatable material with the water, or a combination thereof.

Another exemplary embodiment is directed to a method of preparing a carbonated supplementary cementitious material, the method comprising: mixing a carbonatable material with a pre-heated liquid; and carbonating the carbonatable material to obtain the carbonated supplementary cementitious material, wherein the carbonating comprises flowing a gas comprising carbon dioxide into the carbonatable material for about 0.01 hours to about 72 hours and maintaining a temperature of about 1° C. to about 99° C., and wherein the carbonating is carried out in a high humidity chamber.

The high humidity chamber may have a relative humidity of about 50% to about 100%, about 70% to about 100%, about 80% to about 90%, and the like. The relative humidity can be equal to any integer value or values within any of these ranges, including the end-points of these ranges.

The carbonatable mixture may further comprise MgO and acetic acid. The amount of MgO may be about 0.1 wt % to about 5 wt %, about 0.5 wt % to about 4 wt %, about 1 wt % to about 4 wt %, based on the total mass of the carbonatable mixture, and the like. The amount of acetic acid may be about 0.1 wt % to about 10 wt %, about 3 wt % to about 7 wt %, about 2 wt % to about 5 wt %, based on the total mass of the carbonatable mixture, and the like. The carbonatable mixture may optionally also include a small amount of citric acid. The amount of any of these components can be equal to any integer value or values within any of these ranges, including the end-points of these ranges.

Another exemplary embodiment is directed to a method of preparing a carbonated supplementary cementitious material, the method comprising: introducing a carbonatable material to a reactor; and carbonating the carbonatable material to obtain the carbonated supplementary cementitious material, wherein the carbonating comprises flowing a gas comprising carbon dioxide into the carbonatable material for about 0.01 hours to about 72 hours while agitating or stirring and maintaining a temperature of about 200° C. to about 700° C., about 250° C. to about 650° C., about 300° C. to about 600° C., about 350° C. to about 550° C., about 400° C. to about 500° C., and the like, to obtain the carbonated supplementary cementitious material. The temperature can be equal to any integer value or values within any of these ranges, including the end-points of these ranges.

The gas comprising carbon dioxide may be obtained from a flue gas. The gas may comprise about 10% to about 100% CO₂, by volume, and may preferably comprise about 10% to about 99.99% CO₂, about 15% to about 100% CO₂, about 20% to about 100% CO₂, about 30% to about 100% CO₂, about 40% to about 100% CO₂, about 50% to about 100% CO₂, about 60% to about 100% CO₂, about 70% to about 100% CO₂, about 80% to about 90% CO₂, about 90% to about 100% CO₂, by volume, based on the total volume of the gas comprising CO₂, and the like. A flow rate of the gas comprising carbon dioxide may be from about 1 L/min/Kg of carbonatable material to about 10 L/min/Kg of carbonatable material, and preferably may be from about 2 L/min/Kg to about 9 L/min/Kg, from about 3 L/min/Kg to about 8 L/min/Kg, from about 3 L/min/Kg to about 7 L/min/Kg, from about 3 L/min/Kg to about 6 L/min/Kg, and the like. The process of flowing the gas comprising carbon dioxide into the carbonatable material may be carried out for about 0.5 hours to about 20 hours, about 1 hour to about 15 hours, about 2 hours to about 10 hours, about 3 hours to about 8 hours, about 4 hours to about 7 hours, about 4 hours to about 6 hours, and the like. The numerical value of a specific example of any of these parameters can be equal to any integer value or values within any of these ranges, including the end-points of these ranges.

The process of carbonating the carbonatable material may be carried out in a fluid bed processor, a fluidized paddle blender, a rotary continuous mixer, or a combination thereof. Preferably, the process may be carried out in a fluid bed processor. However, the apparatus is not limited thereto, and any suitable apparatus may be used for this process. The fluid bed processor may be operated at a velocity of about 0.1 m/s to about 3 m/s, about 0.2 m/s to about 2 m/s, about 0.3 m/s to about 1 m/s, about 0.4 m/s to about 1 m/s, about 0.5 m/s to about 1 m/s, and the like. The velocity can be equal to any integer value or values within any of these ranges, including the end-points of these ranges.

This process may further include a step of drying the carbonated supplementary cementitious material for about 5 hours to about 25 hours, about 6 to about 24 hours, about 7 hours to about 23 hours, about 8 hours to about 22 hours, about 9 hours to about 21 hours, about 10 hours to about 20 hours, and the like, at a temperature of about 50° C. to about 150° C., about 60° C. to about 120° C., about 70° C. to about 110° C., about 80° C. to about 100° C., and the like. The numerical value of any specific parameter within these ranges can be equal to any integer value or values within any of these ranges, including the end-points of these ranges.

Another exemplary embodiment is directed to a method of preparing a carbonated supplementary cementitious material, the method comprising: granulating a carbonatable material to form carbonatable material granules; and carbonating the carbonatable material granules, wherein carbonating the carbonatable material granules comprises: flowing a gas comprising carbon dioxide into the carbonatable material granules for about 0.01 hours to about 72 hours, for about 1 hour to about 20 hours, for about 2 hours to about 15 hours, for about 5 hours to about 10 hours, for about 4 hours to about 6 hours, and the like, while agitating or stirring and maintaining a temperature of about 1° C. to about 99° C., about 5° C. to about 90° C., about 10° C. to about 85° C., about 20° C. to about 80° C., about 30° C. to about 70° C., and the like, to obtain the carbonated supplementary cementitious material. The time and temperature can be equal to any integer value or values within any of these ranges, including the end-points of these ranges.

This process may further include a step of drying the carbonated supplementary cementitious material for about 5 hours to about 25 hours, about 6 to about 24 hours, about 7 hours to about 23 hours, about 8 hours to about 22 hours, about 9 hours to about 21 hours, about 10 hours to about 20 hours, and the like, at a temperature of about 50° C. to about 150° C., about 60° C. to about 120° C., about 70° C. to about 110° C., about 80° C. to about 100° C., and the like. The numerical value of any specific parameter within these ranges can be equal to any integer value or values within any of these ranges, including the end-points of these ranges.

The gas comprising carbon dioxide may be obtained from a flue gas. The gas may comprise about 10% to about 100% CO₂, by volume, and may preferably comprise about 15% to about 100% CO₂, about 20% to about 100% CO₂, about 30% to about 100% CO₂, about 40% to about 100% CO₂, about 50% to about 100% CO₂, about 60% to about 100% CO₂, about 70% to about 100% CO₂, about 80% to about 90% CO₂, about 90% to about 100% CO₂, by volume, based on the total volume of the gas comprising carbon dioxide, and the like. A flow rate of the gas comprising carbon dioxide may be from about 1 L/min/Kg of carbonatable material to about 10 L/min/Kg of carbonatable material, and preferably may be from about 2 L/min/Kg to about 9 L/min/Kg, from about 3 L/min/Kg to about 8 L/min/Kg, from about 3 L/min/Kg to about 7 L/min/Kg, from about 3 L/min/Kg to about 6 L/min/Kg, and the like. The numerical value of a specific example of any of these parameters can be equal to any integer value or values within any of these ranges, including the end-points of these ranges.

The granulating may be carried out in a rotary drum granulator, a high shear granulator, a mixer granulator, a compact granulation system, or a combination thereof, but is not limited thereto, and the granulating may be carried out in any suitable apparatus.

The carbonating may be carried out in a rotary drum granulator, a high shear granulator, a mixer granulator, a compact granulation system, a fluid bed processor, a fluidized paddle blender, a rotary continuous mixer or a combination thereof, but is not limited thereto, and the carbonating may be carried out in any suitable apparatus.

The order of performing the granulating and carbonating is not particularly limited, and the granulating and the carbonating may be performed simultaneously or separately.

A moisture content of the granulated carbonatable material is at least about 5%, by mass, preferably about 5% to about 99%, about 6% to about 90%, about 7% to about 80%, about 8% to about 70%, about 9% to about 60%, about 10% to about 50%, by mass, based on the total mass of the granulated carbonatable material, and the like. The numerical value of initial moisture content can be equal to any integer value or values within any of these ranges, including the end-points of these ranges.

In an exemplary embodiment, the method may further comprise adding water to the granules before or during the carbonating to form a carbonatable material granules and water mixture. The resulting mixture may have a liquid to solids ratio (L/S) of about 5 to about 25, about 6 to about 24, about 7 to about 23, about 8 to about 22, about 9 to about 21, about 10 to about 20, about 10 to about 19, about 10 to about 18, about 10 to about 17, about 0 to about 16, about 10 to about 15, and the like. The L/S ratio can be equal to any integer value or values within any of these ranges, including the end-points of these ranges.

The granulated carbonatable material may have a mean particle size (d50) of about 100 μm to about 1200 μm, preferably about 100 μm to about 1100 μm, about 100 μm to about 1000 μm, about 100 μm to about 900 μm, about 100 μm to about 800 μm, about 100 μm to about 700 μm, about 100 μm to about 600 μm, about 100 μm to about 250 μm, about 250 μm to about 300 μm, and the like. The mean particle size (d50) can be equal to any integer value or values within any of these ranges, including the end-points of these ranges. The mean particle size (d50) was measured using a laser diffraction particle sizing method.

The carbonated supplementary cementitious material prepared using this method may have a CO₂ uptake amount of about 5% to about 25%, about 5.5% to about 20%, about 6% to about 18%, about 7% to about 16%, about 8% to about 15%, by mass, and the like. The CO₂ uptake amount can be equal to any integer value or values within any of these ranges, including the end-points of these ranges.

In accordance with exemplary embodiments of the present invention, the carbonatable material can be formed from a first raw material having a first concentration of M is mixed and reacted with a second raw material having a second concentration of Me to form a reaction product that includes at least one synthetic formulation having the general formula MₐMe_{b}O_{c}, MₐMe_{b}(OH)_{d}, MₐMe_{b}O_{c}(OH)_{d} or MₐMe_{b}O_{c}(OH)_{d}•(H₂O)ₑ, wherein M is at least one metal that can react to form a carbonate and Me is at least one element that can form an oxide during the carbonation reaction.

As stated, the M in the first raw material may include any metal that can carbonate when present in the synthetic formulation having the general formula MₐMe_{b}O_{c}, MₐMe_{b}(OH)_{d}, MₐMe_{b}O_{c}(OH)_{d} or MₐMe_{b}O_{c}(OH)_{d}•H₂O)ₑ. For example, the M may be any alkaline earth element, preferably calcium and/or magnesium. The first raw material may be any mineral and/or byproduct having a first concentration of M.

As stated, the Me in the second raw material may include any element that can form an oxide by a hydrothermal disproportionation reaction when present in the synthetic formulation having the general formula MₐMe_{b}O_{c}, MₐMe_{b}(OH)_{d}, MₐMe_{b}O_{c}(OH)_{d} or MₐMe_{b}O_{c}(OH)_{d}•(H₂O)ₑ. For example, the Me may be silicon, titanium, aluminum, phosphorus, vanadium, tungsten, molybdenum, gallium, manganese, zirconium, germanium, copper, niobium, cobalt, lead, iron, indium, arsenic, sulfur and/or tantalum. In a preferred embodiment, the Me includes silicon. The second raw material may be any one or more minerals and/or byproducts having a second concentration of Me.

In accordance with the exemplary embodiments of the present invention, the first and second concentrations of the first and second raw materials are high enough that the first and second raw materials may be mixed in predetermined ratios to form a desired synthetic formulation having the general formula MₐMe_{b}O_{c}, MₐMe_{b}(OH)_{d}, MₐMe_{b}O_{c}(OH)_{d} or MₐMe_{b}O_{c}(OH)_{d}•H₂O)ₑ, wherein the resulting synthetic formulation can undergo a carbonation reaction. In one or more exemplary embodiments, synthetic formulations having a ratio of a:b between approximately 2.5:1 to approximately 0.167:1 undergo a carbonation reaction. The synthetic formulations can also have an O concentration of c, where c is 3 or greater. In other embodiments, the synthetic formulations may have an OH concentration of d, where d is 1 or greater. In further embodiments, the synthetic formulations may also have a H₂O concentration of e, where e is 0 or greater.

The synthetic formulation reacts with carbon dioxide in a carbonation process in the presence of water, whereby M reacts to form a carbonate phase and the Me reacts to form an oxide phase by hydrothermal disproportionation. For example, when wollastonite or rankinite are used as representative formulations, the carbonation reaction proceeds as follows:

Carbonation of Wollastonite:

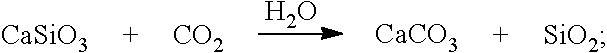

Carbonation of Rankinite:

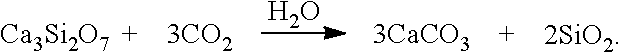

In an example, the M in the first raw material includes a substantial concentration of calcium and the Me in the second raw material contains a substantial concentration of silicon. Thus, for example, the first raw material may be or include limestone, which has a first concentration of calcium. The second raw material may be or include shale, which has a second concentration of silicon. The first and second raw materials are then mixed and reacted at a predetermined ratio to form reaction product that includes at least one synthetic formulation having the general formula (Ca_{w}Mₓ)ₐ(Si_{y}Me_{z})_{b}O_{c}, (Ca_{w}Mₓ)ₐ(Si_{y},Me_{z})_{b}(OH)_{d}, or (Ca_{w}Mₓ)ₐ (Si_{y},Me_{z})_{b} O_{c}(OH)_{d}•(H₂O)ₑ, wherein M may include one or more additional metals other than calcium that can react to form a carbonate and Me may include one or more elements other than silicon that can form an oxide during the carbonation reaction. The limestone and shale in this example may be mixed in a ratio a:b such that the resulting synthetic formulation can undergo a carbonation reaction as explained above. The resulting synthetic formulation may be, for example, wollastonite, CaSiO₃, having a 1:1 ratio of a:b. However, for synthetic formulation where M is mostly calcium and Me is mostly silicon, it is believed that a ratio of a:b between approximately 2.5:1 to approximately 0.167:1 may undergo a carbonation reaction because outside of this range there may not be a reduction in greenhouse gas emissions and the energy consumption or sufficient carbonation may not occur. For example, for a:b ratios greater than 2.5:1, the mixture would require more energy and release more CO₂. Meanwhile for a:b ratios less than 0.167:1, sufficient carbonation may not occur.

In another example, the M in the first raw material includes a substantial concentration of calcium and magnesium. Thus, for example, the first raw material may be or include dolomite, which has a first concentration of calcium, and the synthetic formulation have the general formula (MgᵤCaᵥM_{w})ₐ(Si_{y},Me_{z})_{b}O_{c} or (MgᵤCaᵥM_{w})ₐ(Si_{y}Me_{z})_{b}(OH)_{d}, wherein M may include one or more additional metals other than calcium and magnesium that can react to form a carbonate and Me may include one or more elements other than silicon that can form an oxide during the carbonation reaction. In another example, the Me in the first raw material includes a substantial concentration of silicon and aluminum and the synthetic formulations have the general formula (CaᵥM_{w})ₐ(AlₓSi_{y},Me_{z})_{b}O_{c} or (CaᵥM_{w})ₐ(AlₓSi_{y},Me_{z})_{b}(OH)_{d}, (CaᵥM_{w})ₐ(AlₓSi_{y},Me_{z})_{b}O_{c}(OH)_{d}, or (CaᵥM_{w})ₐ(AlₓSi_{y},Me_{z})_{b}O_{c}(OH)_{d}•(H₂O)ₑ.

Compared to Portland cement, which has an a:b ratio of approximately 2.5:1, the exemplary synthetic formulations of the present invention result in reduced amounts of CO₂ generation and require less energy to form the synthetic formulation, which is discussed in more detail below. The reduction in the amounts of CO₂ generation and the requirement for less energy is achieved for several reasons. First, less raw materials, such as limestone for example, is used as compared to a similar amount of Portland Cement so there is less CaCO₃ to be converted. Also, because fewer raw materials are used there is a reduction in the heat (i.e. energy) necessary for breaking down the raw materials to undergo the carbonation reaction.

Other specific examples of carbonatable materials consistent with the above are described in U.S. Pat. No. 9,216,926 and U.S. provisional application No. 63/151,971, which are incorporated herein by reference in their entirety.

According to further embodiments, the carbonatable material comprises, consists essentially of, or consists of various calcium silicates. The molar ratio of elemental Ca to elemental Si in the composition is from about 0.8 to about 1.2. The composition is comprised of a blend of discrete, crystalline calcium silicate phases, selected from one or more of CS (wollastonite or pseudowollastonite), C3S2 (rankinite) and C2S (belite or larnite or bredigite), at about 30% or more by mass of the total phases. The calcium silicate compositions are characterized by having about 30% or less of metal oxides of Al, Fe and Mg by total oxide mass, and being suitable for carbonation with CO₂ at a temperature of about 30° C. to about 95° C., or about 30° C. to about 70° C., to form CaCO₃ with mass gain of about 10% or more. The calcium silicate composition may also include small quantities of C3S (alite, Ca₃SiO₅). The C2S phase present within the calcium silicate composition may exist in any α-Ca₂SiO₄, β-Ca₂SiO₄ or γ-Ca₂SiO₄ polymorph or combination thereof. The calcium silicate compositions may also include small quantities of residual CaO (lime) and SiO₂ (silica).

Calcium silicate compositions may contain amorphous (non-crystalline) calcium silicate phases in addition to the crystalline phases described above. The amorphous phase may additionally incorporate Al, Fe and Mg ions and other impurity ions present in the raw materials. Each of these crystalline and amorphous calcium silicate phases is suitable for carbonation with CO₂. The calcium silicate compositions may also include small quantities of residual CaO (lime) and SiO₂ (silica).

Each of these crystalline and amorphous calcium silicate phases is suitable for carbonation with CO₂.

The calcium silicate compositions may also include quantities of inert phases such as melilite type minerals (melilite or gehlenite or akermanite) with the general formula (Ca,Na,K)₂ [(Mg, Fe²⁺, Fe³⁺, Al, Si)₃ O₇] and ferrite type minerals (ferrite or brownmillerite or C₄AF) with the general formula Ca₂ (Al,Fe³⁺)₂ O₅. In certain embodiments, the calcium silicate composition is comprised only of amorphous phases. In certain embodiments, the calcium silicate comprises only of crystalline phases. In certain embodiments, some of the calcium silicate composition exists in an amorphous phase and some exists in a crystalline phase.

Each of these calcium silicate phases is suitable for carbonation with CO₂. Hereafter, the discrete calcium silicate phases that are suitable for carbonation will be referred to as reactive phases under the conditions described herein. The reactive phases may be present in the composition in any suitable amount. In certain preferred embodiments, the reactive phases are present at about 50% or more by mass based on the total content of the carbonatable composition.

The various reactive phases may account for any suitable portions of the overall reactive phases. In certain preferred embodiments, the reactive phases of CS are present at about 10 to about 60 wt %; C3S2 in about 5 to 50 wt %; C2S in about 5 wt % to 60 wt %; C in about 0 wt % to 3 wt %.

In certain embodiments, the reactive phases comprise a calcium-silicate based amorphous phase, for example, at about 40% or more (e.g., about 45% or more, about 50% or more, about 55% or more, about 60% or more, about 65% or more, about 70% or more, about 75% or more, about 80% or more, about 85% or more, about 90% or more, about 95% or more) by mass of the total phases. It is noted that the amorphous phase may additionally incorporate impurity ions present in the raw materials.

It should be understood that, calcium silicate compositions, phases and methods disclosed herein can be adopted to use magnesium silicate phases in place of or in addition to calcium silicate phases. As used herein, the term “magnesium silicate” refers to naturally-occurring minerals or synthetic materials that are comprised of one or more of a groups of magnesium-silicon-containing compounds including, for example, Mg₂SiO₄ (also known as “forsterite”) and Mg₃Si₄O₁₀ (OH)₂ (also known as “talc”) and CaMgSiO₄ (also known as “monticellite”), each of which material may include one or more other metal ions and oxides (e.g., calcium, aluminum, iron or manganese oxides), or blends thereof, or may include an amount of calcium silicate in naturally-occurring or synthetic form(s) ranging from trace amount (1%) to about 50% or more by mass.

Another exemplary embodiment is directed to a method for forming cement or concrete, the method comprising: forming a carbonated supplementary cementitious material according to any of the exemplary method described herein; combining the carbonated supplementary cementitious material with a hydraulic cement composition to form a mixture, wherein the mixture comprises about 1% to about 99%, by mass, of the carbonated supplementary cementitious material, based on the total mass of solids in the mixture; and reacting the mixture with water to form the cement or concrete. The mixture may comprise about 20% to about 35% of the carbonated supplementary cementitious material by mass, based on the total mass of solids in the mixture. The hydraulic cement may comprise one or more of ordinary Portland cement (OPC), calcium sulfoaluminate cement (CSA), belitic cement, or other calcium based hydraulic material. This method may further comprise adding an aggregate to the mixture, and the aggregate may be coarse and/or fine aggregates. The resulting cement or concrete may be suitable for various applications, including but not limited to foundations, road beds, sidewalks, architectural slabs, pavers, CMUs, wet cast tiles, segmented retaining walls, hollow core slabs, and other cast and pre-cast applications. The resulting cement or concrete may also be suitable for use in the preparation of a mortar appropriate for masonry applications.

Other specific examples of carbonatable calcium silicate materials consistent with the above are described in U.S. Pat. No. 10,173,927, which is incorporated herein by reference in its entirety. Other non-limiting examples of the carbonatable calcium silicate material and additional details of the supplementary cementitious material, and the incorporation thereof in ordinary Portland cement and the like, consistent with the above are described in U.S. provisional Application No. 63/151,971, which is incorporated herein by reference in its entirety.

The principles of the present invention, as well as certain exemplary features and embodiments thereof, will now be described by reference to the following non-limiting examples of the different carbonation processes described herein.

### Example 1—Cyclic Carbonation Process

A cyclic carbonation process includes alternating drying and wetting cycles. The very first “dry” cycle in the cyclic carbonation includes heating a powder sample of a carbonatable material to a high temperature between 80° C. to 95° C. in dry CO₂. In this process, premature boiling of the water injected at the chamber temperature of, e.g., 100° C. to 105° C., should be avoided. The consecutive wet cycle injects liquid water into the carbonation chamber and to the powder sample of the carbonatable material, and the wet cycle is of short duration (just enough time to enrich the water film surrounding the warm cement particles in CO₂ (aq)—H₂CO₃(aq)—HCO₃⁻(aq) species). The water starts its evaporation within minutes. The water film becomes continuously enriched in terms of the above chemical species, and just few short minutes before its complete evaporation the water film will be supersaturated with respect to CaCO₃ nucleation and the very last aqueous species in that diminishing water film is CO₃⁻ (aq) owing to the high pH Ca²⁺ (aq) on the surface of the moist pozzolan layer of high BET surface area, which will combine with CO₃²⁻ (aq) to form CaCO₃ (s). The dry cycle following the wet cycle is for the transformation of any small amounts of Ca(HCO₃)₂ into CaCO₃ (s).

### Example 2—Semi-Wet Carbonation Process

In the semi-wet carbonation process, water was added to the carbonatable material, and the moisture content of the carbonatable material was increased to about 9% by placing it into a plastic barrel with the required amount of water and rolling it for several hours. The moistened carbonatable material was spread out into several trays to maximize the exposed solid-gas interfacial surface area. The depth of the powder bed was ≤1 inch. Agglomerates were manually broken up with a trowel where possible. The several trays were then placed in a carbonation chamber for several curing cycles. A strip of thermocouples was placed underneath the bed of carbonatable material in one of the trays, as shown at the bottom right corner of FIG. 1. Samples were taken between curing cycles for measurement of mass gain by loss on ignition. The carbonatable material was re-wetted and rolled in the plastic barrel between each carbonation cycle. The resultant carbonated material was extremely agglomerated, with agglomerates reaching several millimeters in diameter. The material was ground in an F.C. Bond Bico ball mill, using a standard charge of steel media (285 balls of various sizes, totaling about 20 kg). The material was ground in 5 kg batches for about 1.5 hours. The material exiting the mill was passed through a 75 μm sieve to remove the coarse particles, which were returned to the mill.

The carbonation and temperature profiles of the thermocouple strip are shown in FIG. 2. As shown in FIG. 2, a large exothermic reaction occurs immediately upon contact with carbon dioxide gas (the purge was not captured in the chamber data). Appreciable exothermic reaction is present during the first cycle. Subsequent carbonation cycles have a longer duration, but similar conditions.

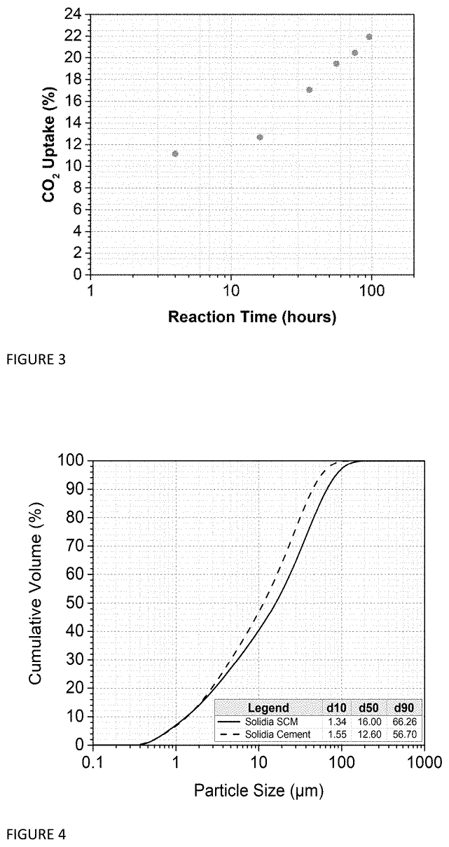

Loss of carbonatable material on ignition was measured from 450° C. to 1000° C., and the CO₂ uptake of the SCM was calculated from this value. A graphical representation of CO₂ uptake as a function of the reaction time is shown in FIG. 3. The carbonatable material was carbonated for a total of about 96 hours. As shown in FIG. 3, almost half of the total mass gain occurred within the first four hours of carbonation.

The particle size distribution of the SCM material was measured using laser diffraction particle sizing after grinding and sieving, and the distribution is shown in FIG. 4. The carbonated and ground SCM has a similar fine content, but slightly higher d50 and d90 values.

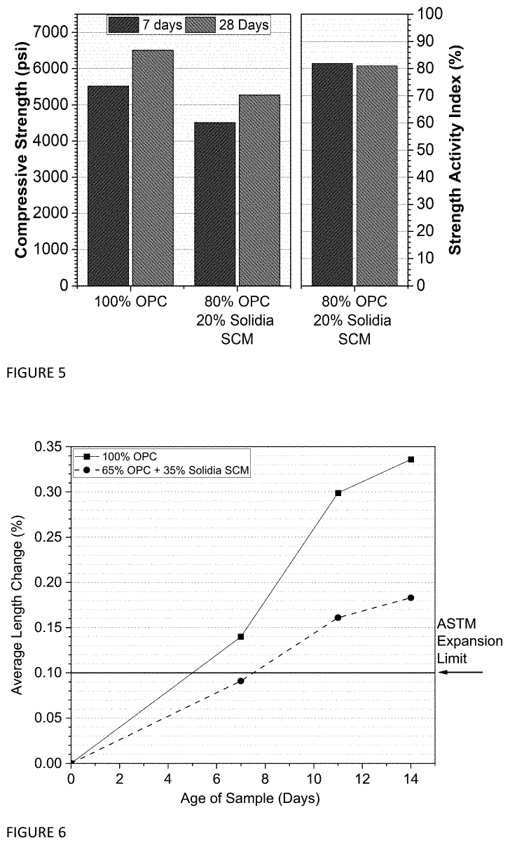

A Strength Activity Index (SAI) Test and an ASTM C1567 AST Mitigation Test were also carried out on the resulting SCM. The ASTM C311 standard for fly ash and natural pozzolans calls for a minimum 7-day and 28-day strength activity index (SAI) of 75%. The SAI is essentially the relative strength of a standard mortar cube with 20% of the cement replaced with the SCM, compared to a similar 100% OPC mortar. FIG. 5 shows the compressive strength of the OPC control and the test mortar, and the SAI index of the test mortar. The carbonated SCM powder meets the ASTM requirement of 75%. However, the SAI does not increase over time (7 days to 28 days), as is typically indicative of pozzolanic activity.

Results of the ASTM C1567 standard test method for determining potential alkali-silica reactivity (ASR) are shown in FIG. 6. As shown in FIG. 6, an expansion greater than 0.10% in 14 days is indicative of potentially deleterious expansion. While the SCM prepared using the semi-wet carbonation process did exceed the ASTM specified limit, the expansion of the SCM was only about half that of the OPC control.

For the semi-wet carbonation process, much of the carbonation reaction happens immediately upon contact of moist cement with carbon dioxide gas. Within four hours, the cement gained about 10% of its mass in CO₂. It takes exponentially longer to reach near complete reaction with this method. In this case, it took 96 total hours of carbonation, with wetting cycles in between, to reach an uptake of about 22%. The SCM prepared using this method is highly agglomerated and requires grinding to produce a suitable SCM. The resulting SCM meets the ASTM C311 strength activity index requirement of 75%, but the SAI does not increase from 7 to 28 days, and exceed the ASTM C1567 specified limit for expansion due to ASR, but still mitigates about half of the expansion compared to the OPC control.

### Example 3—Non-Slurry Carbonation Process

Pre-Wetted Method: In this process, a pre-heated carbonatable material was pre-wetted with a pre-specified amount of pre-heated liquid (typically, L/S=0.20, which means 16.67 wt % water presence in the wet-body), then carbonation was initiated in a high humidity chamber (e.g., having a relative humidity of 87%).

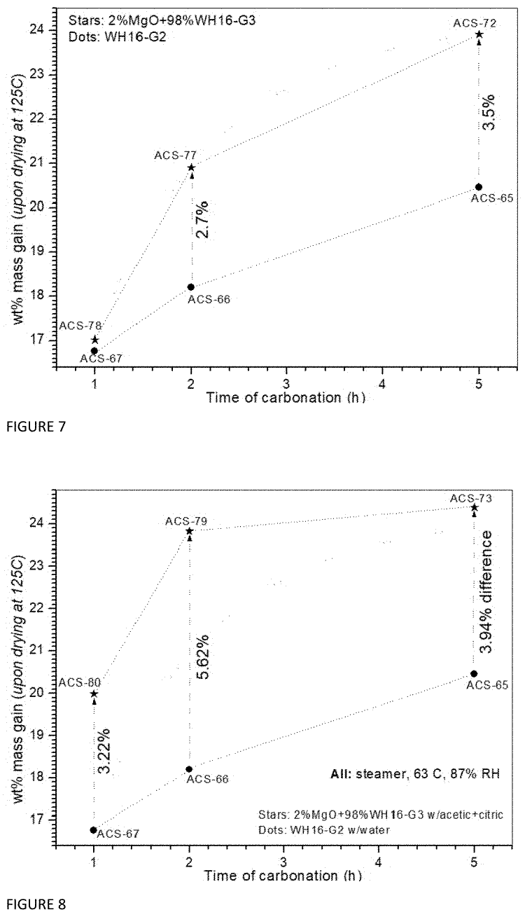

In one example of the pre-wetted method, supersack-size powder blend of 2 wt % MgO and 98 wt % of a carbonatable material (Solidia Cement™) was mixed with 5 wt % acetic acid solution (prepared by diluting a 50% acetic acid solution down to 5% by volume using tap water). Particularly, 10 g of the carbonatable material was mixed with 2 g of 5% acetic acid for about one minute, followed by placing fine particulates of the moist mix into a clean Al pan as the static sample holder in a steam chamber operated at 3 psi CO₂. Carbonation was carried out for 1 h, 2 h and 5 h at 63° C. (sample temperature) and 87% relative humidity (RH). Improvements in the percentage mass gain values and the CO₂ uptake values on using the 2% MgO+98% carbonatable material+5% acetic acid mixture are shown in FIGS. 7 and 8. The phase percentages of the final SCM after 1, 2 and 5 hours of carbonation, measured using X-Ray diffraction and the Rietveld method, are shown in Table 1:

TABLE 1

| | Initial | | | |
|---|---|---|---|---|
| | Carbonatable | | | |
| | Material with | SCM after | SCM after | SCM after |
| | 2 wt % MgO | 1 hour of | 2 hours of | 5 hours of |
| Phases | (wt %) | carbonation | carbonation | carbonation |
| Akermanite | 17.6% | 12.4% | 12.3% | 14.0% |
| Rankinite | 23.1% | 8.2% | 5.7% | 3.4% |
| Pseudo-wollastonite | 16.3% | 7.4% | 5.0% | 3.1% |
| Larnite | 1.9% | — | — | — |
| Calcite | — | 4.5% | 4.5% | 7.8% |
| Aragonite | — | 8.8% | 13.9% | 18.7% |
| Vaterite | — | 1.4% | 1.2% | 1.0% |
| SiO₂ | 5.6% | 4.6% | 4.6% | 5.6% |
| MgO | 0.7% | — | — | — |
| Amorphous | 34.8% | 52.7% | 52.8% | 46.4% |

As seen from the results in Table 1, the amorphous content of the carbonatable material increases after carbonation using this process.

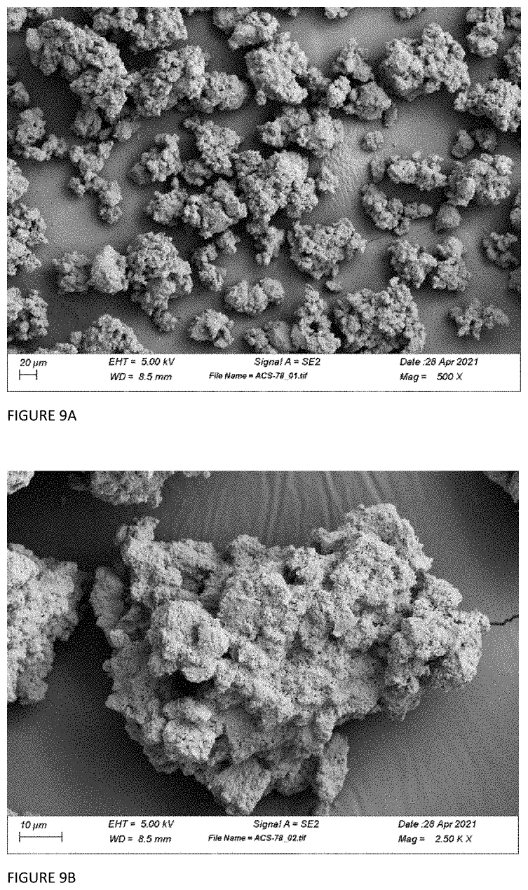

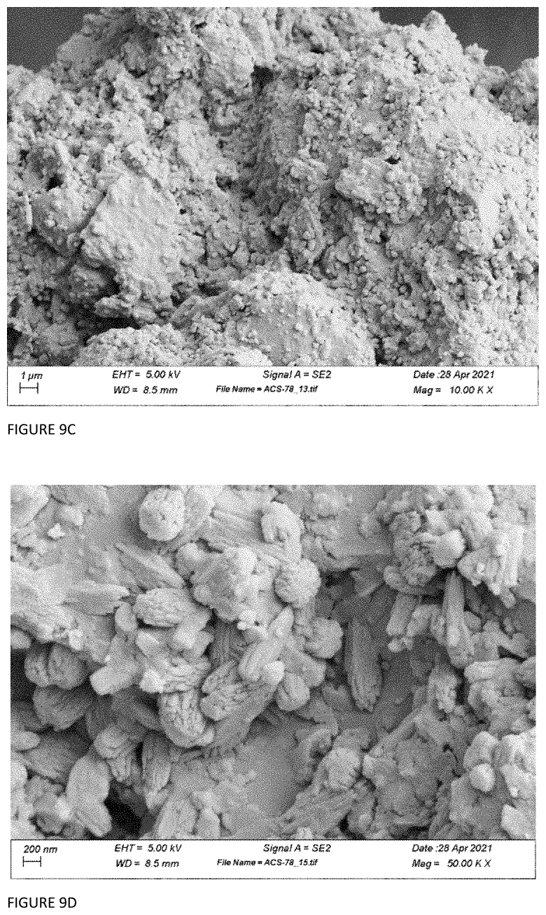

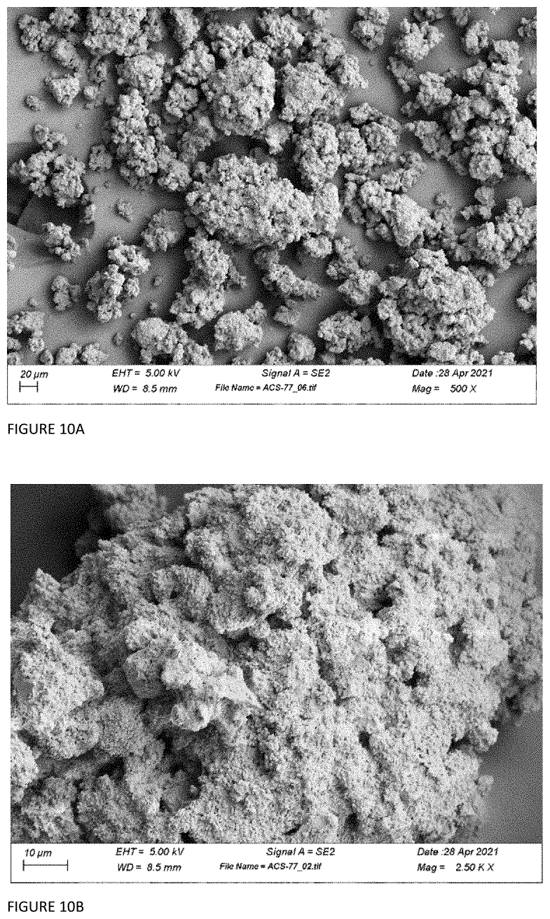

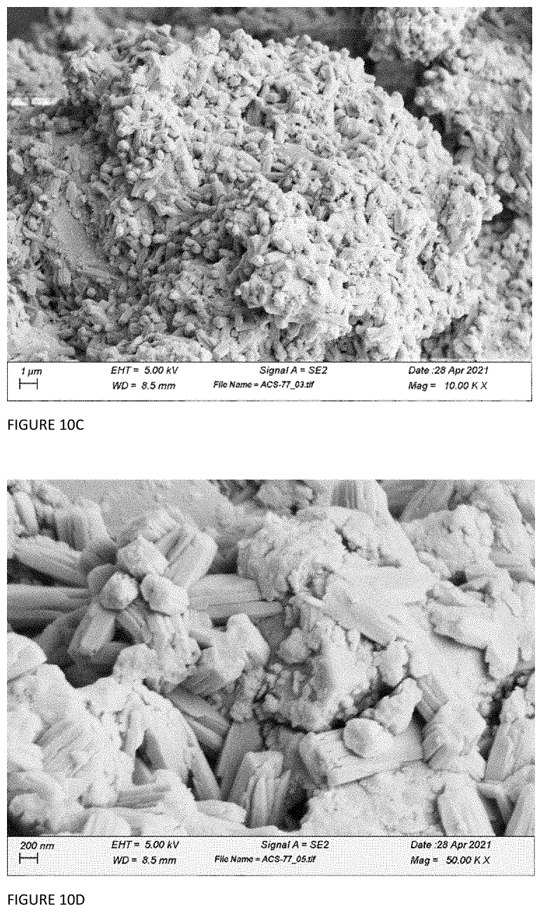

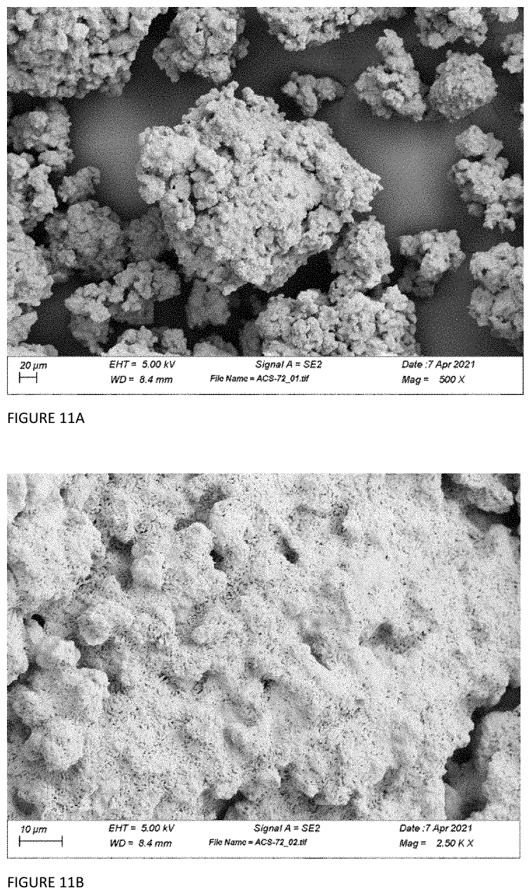

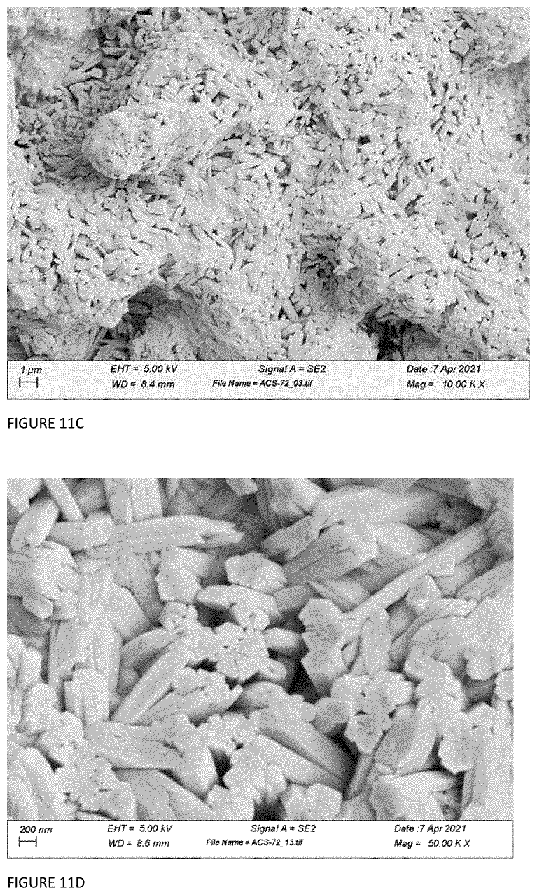

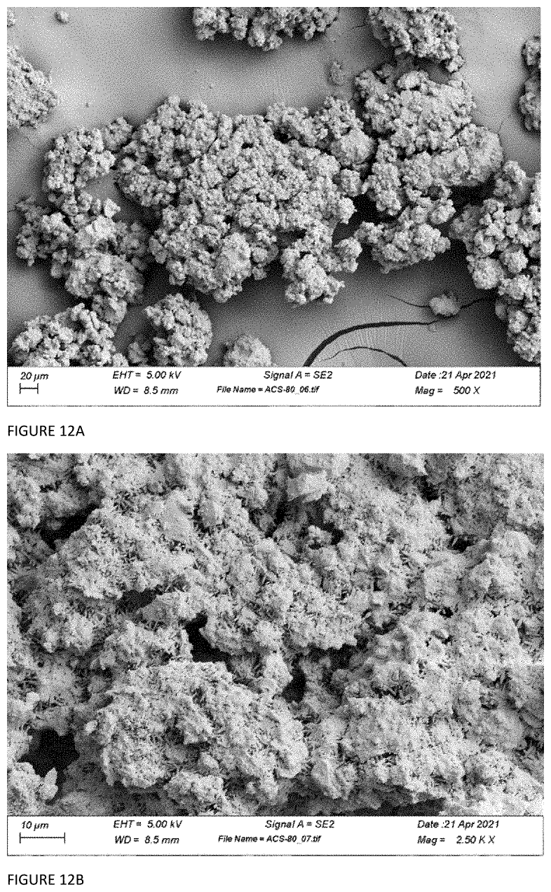

The microstructure of the resulting SCM is shown in the SEM images of FIGS. 9A-11D. The CO₂ intake is 13.32 wt % after 1 hour of carbonation, 15.21 wt % after 2 hours of carbonation, and 19.04 wt % after 5 hours of carbonation.

In another example of the pre-wetted method, a supersack-size powder blend of 2 wt % MgO and 98 wt % of a carbonatable material (Solidia Cement™) was mixed with 5 wt % acetic acid solution (prepared by diluting a 50% acetic acid solution down to 5% using tap water) and a small amount of citric acid. Particularly, 10 g of the carbonatable material was mixed with 2 g of 5% acetic acid, with 22 mg citric acid dissolved in the acetic acid solution, for about one minute, followed by placing fine particulates of the moist mix into a clean Al pan as the static sample holder in a steam chamber operated at 3 psi CO₂. Carbonation was carried out for 1, 2 and 5 h at 63° C. (sample temperature) and 87% RH. The phase percentages of the final SCM after 1 h, 2 h and 5 h of carbonation, measured by X-Ray diffraction and the Rietveld method, are shown in Table 2:

TABLE 2

| | Initial | | | |
|---|---|---|---|---|
| | Carbonatable | | | |
| | Material with | SCM after | SCM after | SCM after |
| | 2% wt % MgO | 1 hour of | 2 hours of | 5 hours of |
| Phases | (wt %) | carbonation | carbonation | carbonation |
| Akermanite | 17.6% | 12.5% | 12.5% | 11.9% |
| Rankinite | 23.1% | 7.3% | 4.8% | 4.5% |
| Pseudo-wollastonite | 16.3% | 6.2% | 4.6% | 4.1% |
| Larnite | 1.9% | — | — | — |
| Calcite | — | 2.0% | 3.9% | 5.1% |
| Aragonite | — | 8.7% | 14.4% | 9.7% |
| Vaterite | — | 7.7% | 9.0% | 9.4% |
| SiO₂ | 5.6% | 6.1% | 5.6% | 4.6% |
| MgO | 0.7% | — | — | — |
| Amorphous | 34.8% | 48.5% | 45.2% | 50.6% |

As seen from the results in Table 2, the amorphous content of the carbonatable material increases after carbonation using this process.

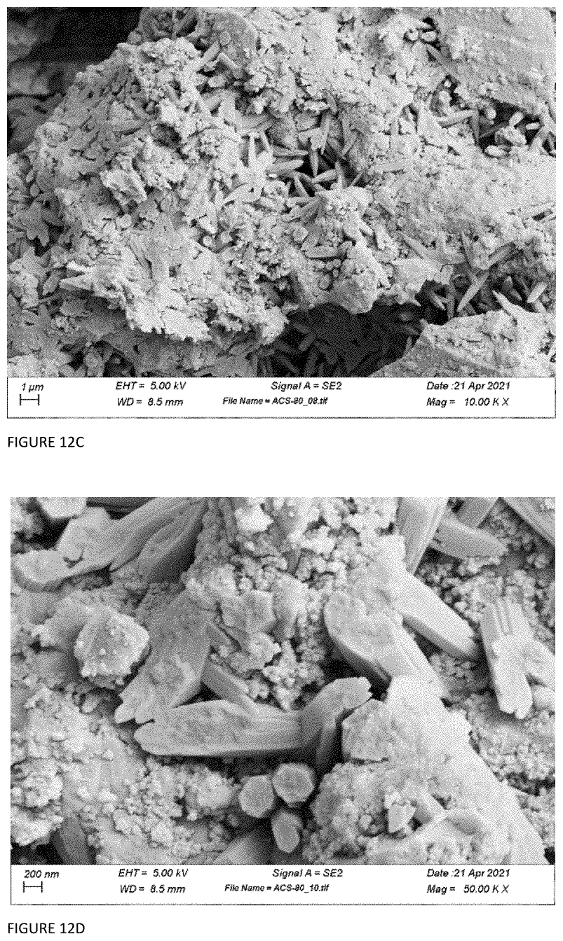

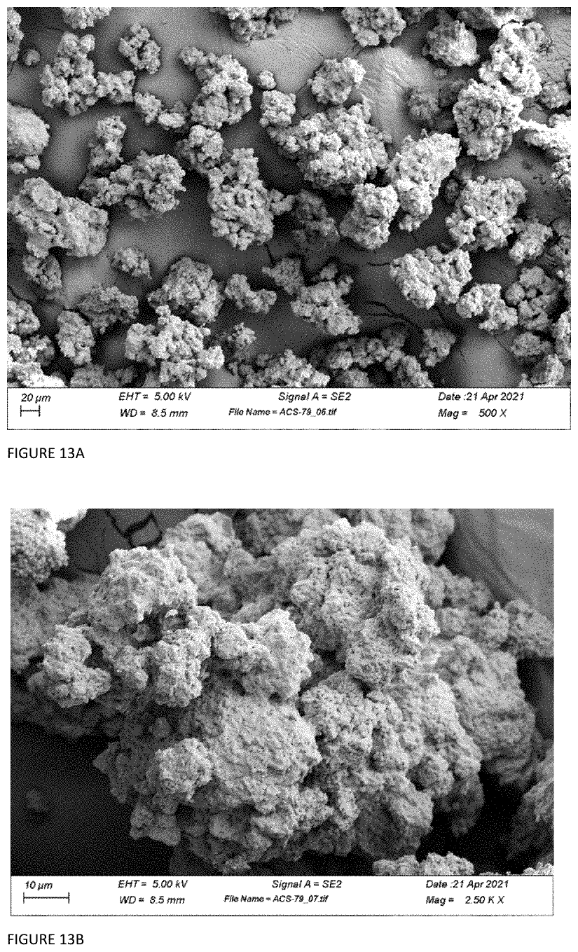

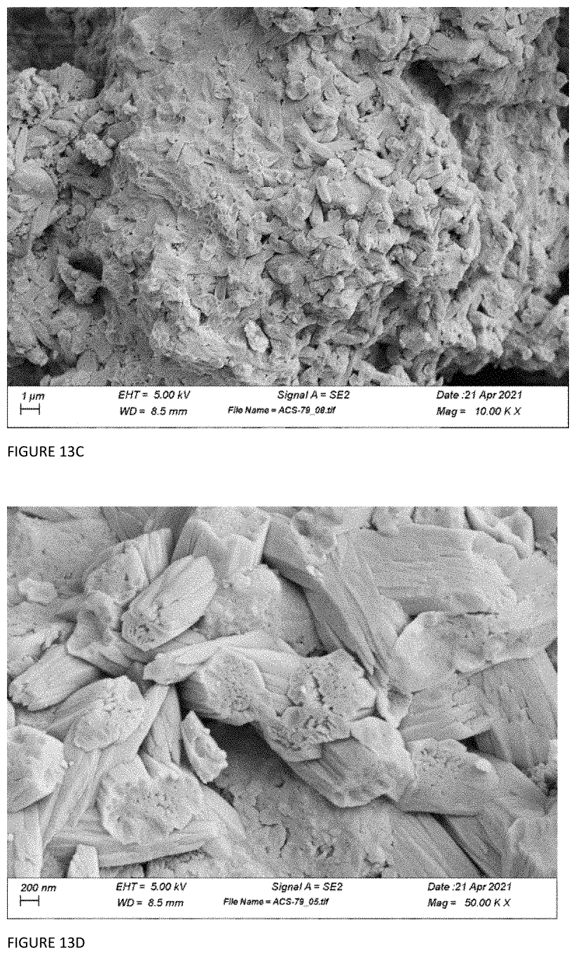

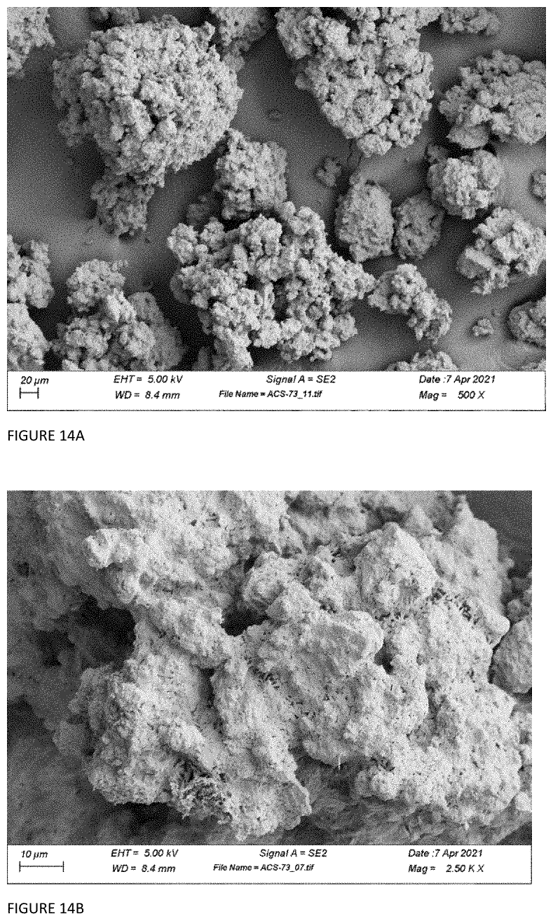

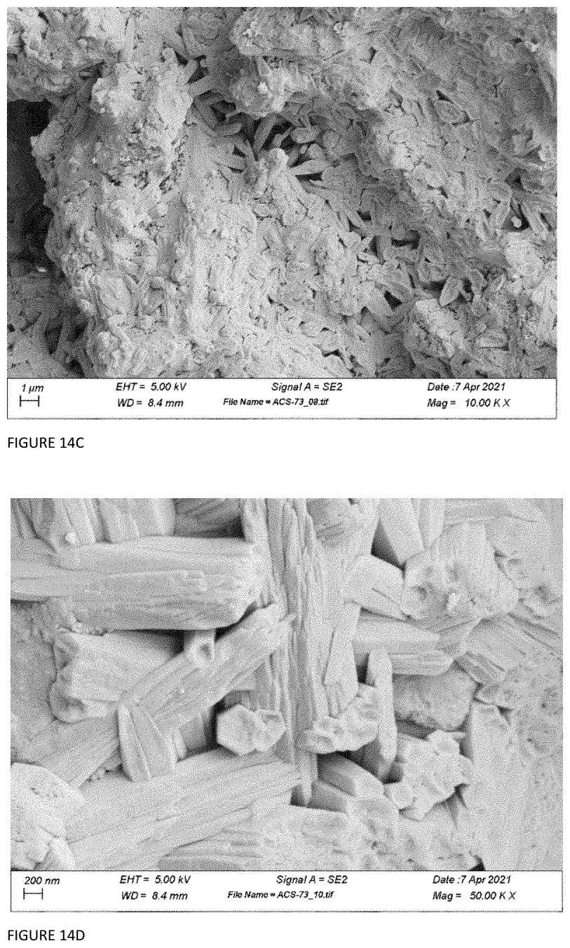

The microstructure of the resulting SCM is shown in the SEM images of FIGS. 12A to 14D. The CO₂ intake is 15.17 wt % after 1 hour of carbonation, 17.50 wt % after 2 hours of carbonation, and 18.47 wt % after 5 hours of carbonation.

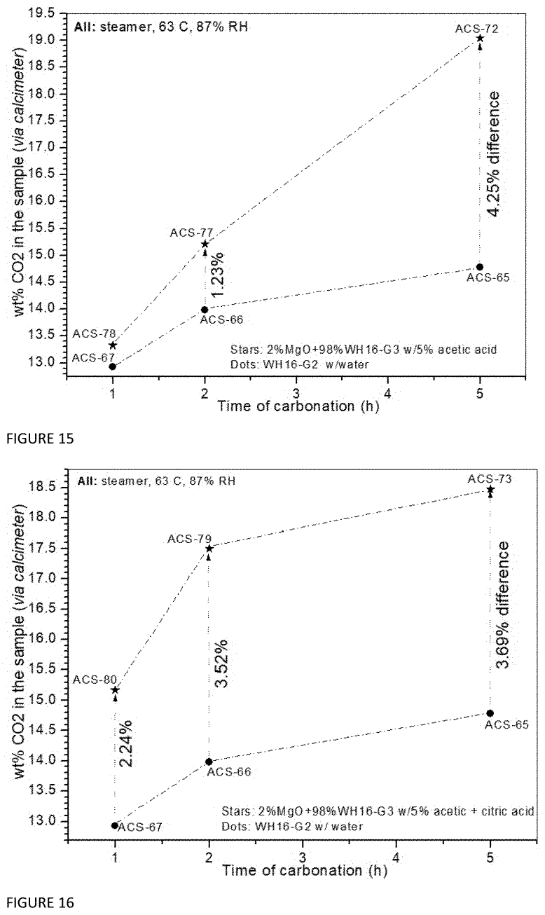

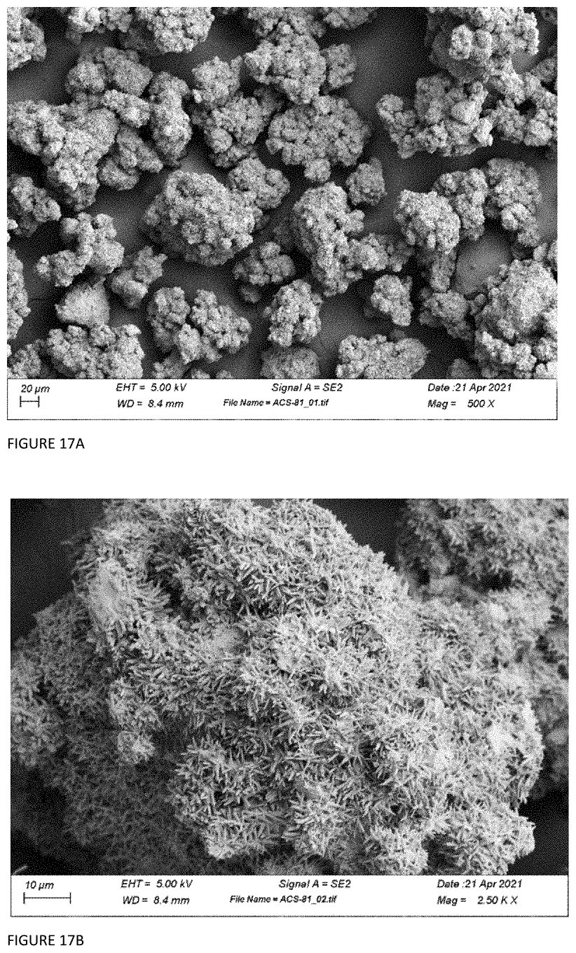

As shown in FIG. 15, using both the 2 wt % MgO additive and the 5 wt % acetic acid solution increased the CO₂ uptake values to about 19% after 5 hours of carbonation, which is an unexpectedly high value for a non-agitated (i.e., static) carbonation chamber. Similarly, as shown in FIG. 16, using both the 2% MgO additive and 5 wt % acetic acid (plus a low dosage of citric acid) increased the CO₂ uptake value to about 19% for a 5 h run. Citric acid also promotes the formation of magnesian-calcite and suppresses the formation of vaterite. The amount of acetic acid can also be reduced to 2 wt % from 5 wt % without observing any change in the CO₂ uptake value, as shown in Table 3:

TABLE 3

| Sample | % Mass Gain | % CO₂ Uptake |
|---|---|---|
| Carbonatable material + | 20.45 | 14.78 |
| Tap Water | | |
| 2 wt % MgO-98% carbonatable | 24.39 | 18.47 |
| material + 5 wt % acetic | | |
| acid with a small dose of | | |
| citric acid pre-dissolved | | |
| in the acetic acid solution | | |
| 2 wt % MgO-98% WHi6 blend + | 27.31 | 18.47 |
| 2 wt % acetic acid with a small | | |
| dose of citric acid pre-dissolved | | |
| in the acetic acid solution | | |

Changes in the phase percentages based on the amount of acetic acid included in the pre-wetting or wetting liquid were also studied using X-Ray diffraction techniques, and the results are shown in Table 4:

TABLE 4

| | | | SCM after 5 hours | SCM after 5 hours |
|---|---|---|---|---|
| | | SCM after | of carbonation using | of carbonation using |
| | Initial Carbonatable | 5 hours of | 5 wt % acetic acid | 2 wt % acetic acid |
| | Material with 2% | carbonation | with a small dose of | with a small dose of |
| Phases | wt % MgO (wt %) | using tap water | pre-dissolved citric acid | pre-dissolved citric acid |
| Akermanite | 17.6% | 13.4% | 11.9% | 11.4% |
| Rankinite | 23.1% | 8.6% | 4.5% | 3.4% |
| Pseudo-wollastonite | 16.3% | 4.9% | 4.1% | 2.1% |
| Larnite | 1.9% | — | — | — |
| Calcite | — | 17.5% | 5.1% | 2.8% |
| Aragonite | — | 1.0% | 9.8% | 16.4% |
| Magnesium-calcite | — | — | 9.4% | 6.3 |
| Vaterite | — | 2.8% | — | 0.6% |
| SiO₂ | 5.6% | 2.9% | 4.6% | 6.3% |
| MgO | 0.7% | — | — | — |
| Amorphous | 34.8% | 48.9% | 50.6% | 50.7% |

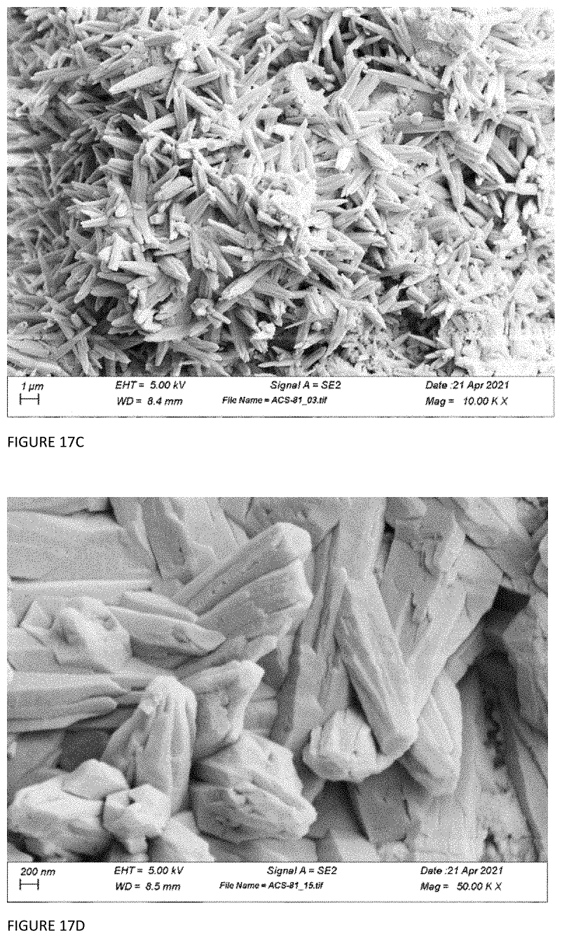

FIGS. 17A to 17D are SEM images, at different magnifications, of the microstructure of the SCM after carbonation for 5 hours using a mixture of 5 wt % MgO and 2 wt % acetic acid, with a small dose of pre-dissolved citric acid, as the pre-wetting or wetting liquid, which results in 18.47 wt % CO₂ uptake. Increase in surface area in such high reactivity CaCO₃ phases is essential to have a high reactivity SCM in an OPC-concrete matrix. Water demand/flow can be improved by “intergrinding” the OPC and the SCM powders described herein prior to concrete preparation.

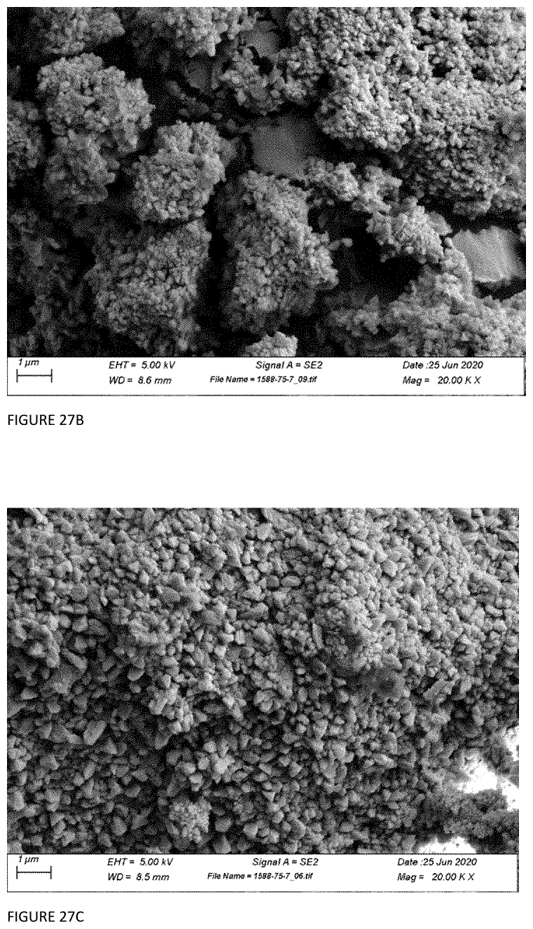

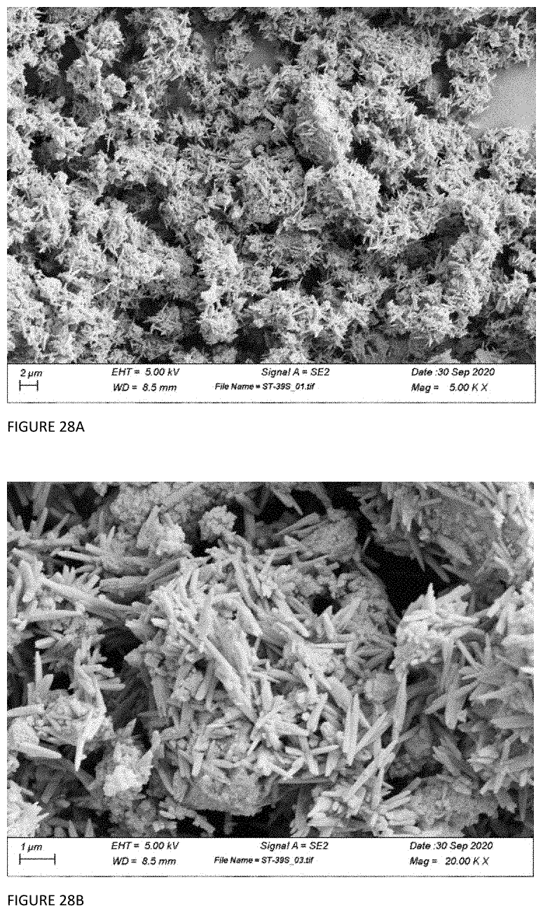

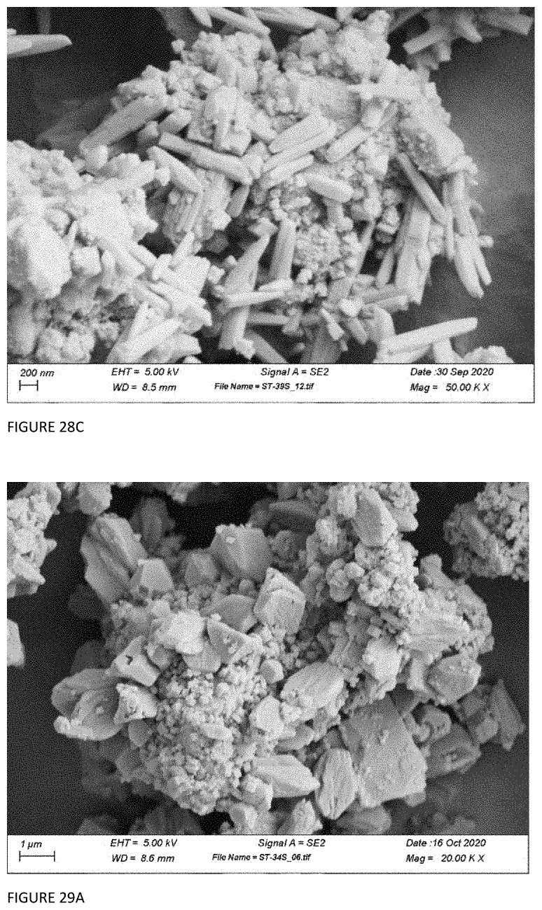

FIGS. 26A to 28C are SEM images of the microstructure of the carbonated SCM after carbonation in a dilute slurry, which does not include an admixture of carboxylic acid additive, where the L/S ratio is 2.33 (i.e., 2.33 tons of water per ton of carbonatable material), and where the carbonation is carried out in 100% CO₂ at a temperature of 60° C. (FIGS. 26A to 26C); after carbonation in a slurry, which includes MgO, a low-dose of Glenium-7500™ water-reducer and a low dosage of citric acid, where the L/S ratio is 1.44 (i.e., 1.44 tons of water per ton of 2% MgO-98% carbonatable material), and where the carbonation is carried out in 100% CO₂ at a temperature of 60° C. (FIGS. 27A to 27C); and after carbonation in a slurry, which includes MgO, but does not include a water-reducer and does not include citric acid, where the L/S ratio is 2.33 (i.e., 2.33 tons of water per ton of 2% MgO-98% carbonatable material), and where the carbonation is carried out in 100% CO₂ at a temperature of 60° C. (FIGS. 28A to 28C). As seen from these SEM images, the material of FIGS. 26A to 26C includes only calcite, the material of FIGS. 27A to 27C includes only magnesian-calcite ((Ca, Mg)CO₃) and has good ASR performance, and the material of FIGS. 28A to 28C includes aragonite as a major phase and calcite as a minor phase. These SEM images show the Mg-induced change in the CaCO₃ polymorph.

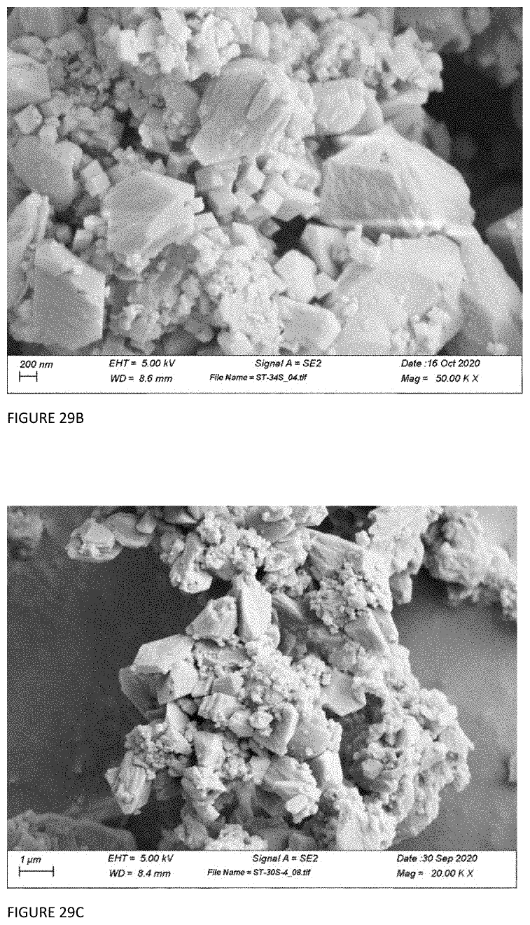

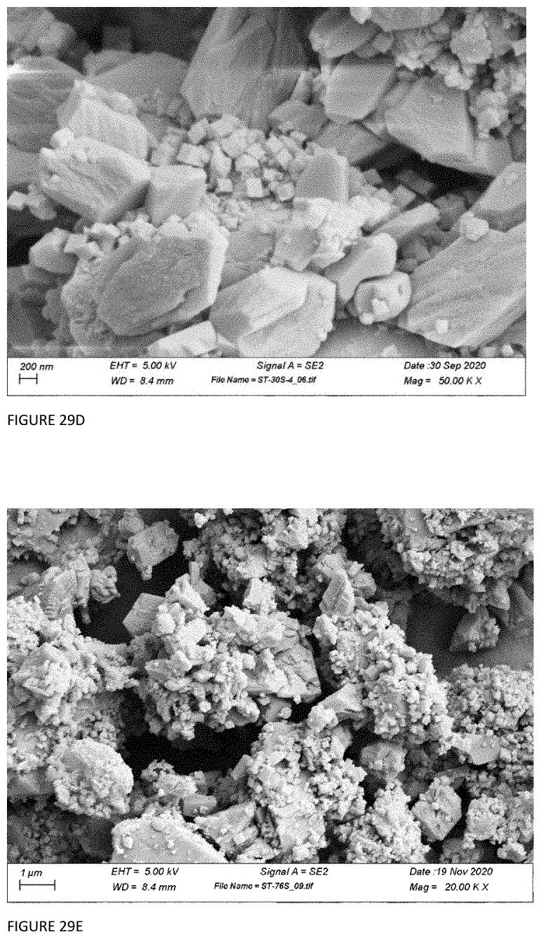

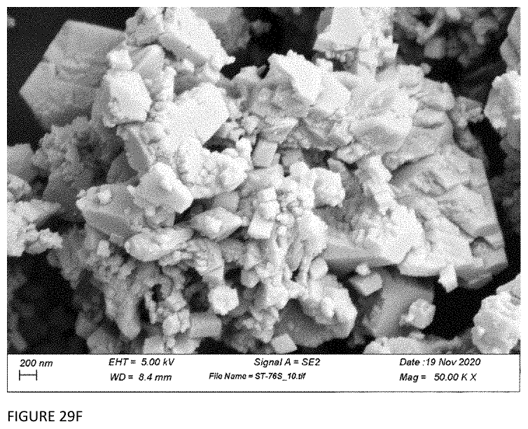

FIGS. 29A to 29F are SEM images showing the change in CaCO₃ polymorph microstructure based on a change in the CO₂ feeding rate. Specifically, the CO₂ feeding rate was 162.8 L CO₂/h/kg of carbonatable material (FIGS. 29A and 29B, BET surface area: 8.3 m²/g), 114 L CO₂/h/kg of carbonatable material (FIGS. 29C and 29D, BET surface area: 9.8 m²/g), and 32.6 L CO₂/h/kg of carbonatable material (FIGS. 29E and 29F, BET surface area: 10.2 m²/g). As seen from FIGS. 29A to 29F, microstructural attributes did not change much with a change in the CO₂ feed rate; however, with a decrease in the CO₂ feed rate, the amount of uncarbonated/unreacted C3S2 and CS increased drastically.

Dry Powder Method: In an alternate non-slurry carbonation method, a dry carbonatable material powder was heated to 95° C. Small aliquots of a liquid was then sprayed (to obtain an L/S ratio of 0.08) and held under a CO₂ atmosphere until the liquid was consumed and/or evaporated, followed by wetting the partially reacted sample with another aliquot of liquid aerosol spray (the L/S ratio becomes 0.16 in the second wetting cycle). This process was repeated multiple times, for example, for nineteen (19) cycles. After 19 cycles, the total amount of liquid sprayed resulted in an L/S=1.52, (0.08 19=1.52). The total process lasts for 5 h and the product is a dry powder. The 20th cycle is for drying the carbonated material in a hot (91° C.), vertical cyclic evaporation/carbonation chamber with a vent and/or chiller.

### Example 4—High-Temperature Carbonation Process

The concept behind the SCM carbonation at high temperature is an extension of well-known low-temperature carbonation methods crossed with an understanding of the equilibrium between carbonation and calcination. This high-temperature equilibrium is well understood for CaO as a CO₂ sorbent, such as the calcium looping method (CaL) nearing commercial deployment for carbon capture and storage (CCS). Similar equilibria exist for calcium silicates, although less well-known than that of pure CaO. At low temperatures (below the boiling point of water), carbonation of calcium silicates is known to occur even without the presence of liquid water. Thus, high temperature carbonation is an extension of those “dry” low-temperature reaction mechanisms, making use of the increase in reaction rate with temperature.

In high-temperature SCM carbonation, a CO₂-containing humid gas is delivered to a carbonation reactor at temperatures well in excess of the boiling point of water. The reactor temperature may range from 200° C. to 700° C. In the carbonation reactor, carbonatable material of appropriate fineness is introduced and agitated for efficient gas-solid contact. The exothermic carbonation reaction takes place at the particle surfaces of the carbonatable material, producing crystalline CaCO₃ and amorphous silicate-rich structures. These amorphous silicate-rich structures have a high pozzolanic reactivity. This pozzolanic reactivity, in addition to the well-known benefits of fine limestone (CaCO₃) in OPC-based concrete, forms the basis of the SCM product prepared using the high-temperature carbonation process.

An extremely common CO₂-containing humid gas at high temperature is flue gas. In particular, cement plant flue gases are especially rich in CO₂, due to the calcination of limestone required for clinker reactions. This makes cement plants an especially attractive location for the implementation of high-temperature SCM carbonation. The reasons are: (1.) CO₂-containing humid gases are readily available at the required temperature; (2.) there is no need for added heat to drive the carbonation; and (3.) the SCM produced can be used to produce a blended cement product without added logistical costs.

A fluidized bed reactor may be an appropriate apparatus for carrying out a high-temperature carbonation process, but is not limited thereto, and carbonation in the fluidized bed reactor may be carried out at any temperature from ambient temperature to 700° C. A fluidized bed reactor is a well-known gas-solid contacting reactor. A bed of particles is said to be fluidized when the gas flowing through creates a drag force which equals the weight of the particles. At the onset of fluidization, the combined gas-solid system begins to behave like a liquid. Fluidized bed reactors are generally vertical cylinders in which gas is evenly distributed at the bottom, fluidizing a bed of particles above, followed by space to disengage solids from the gas, and finally a cyclone arrangement to remove dust and fines. The reactors have numerous uses in the chemical process industries for their excellent mass and heat transfer properties. They are especially amenable to fast heterogeneous catalytic reactions.

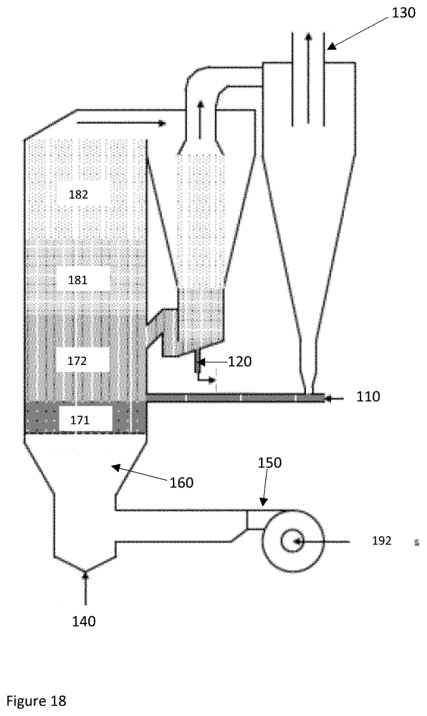

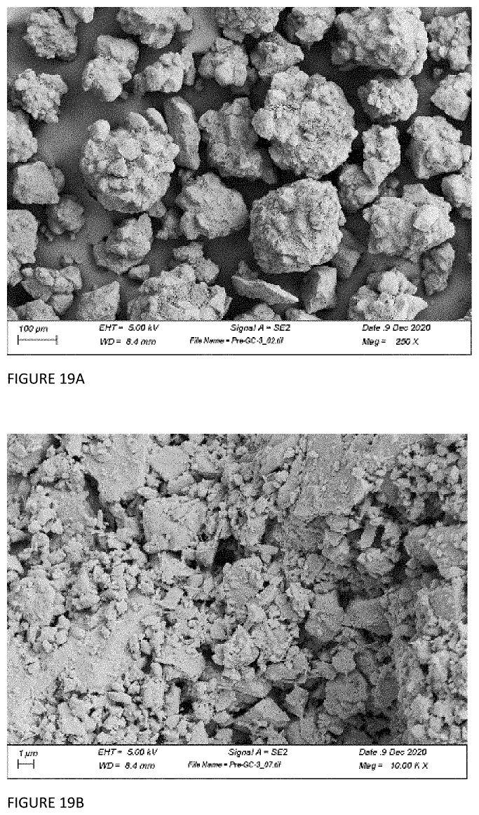

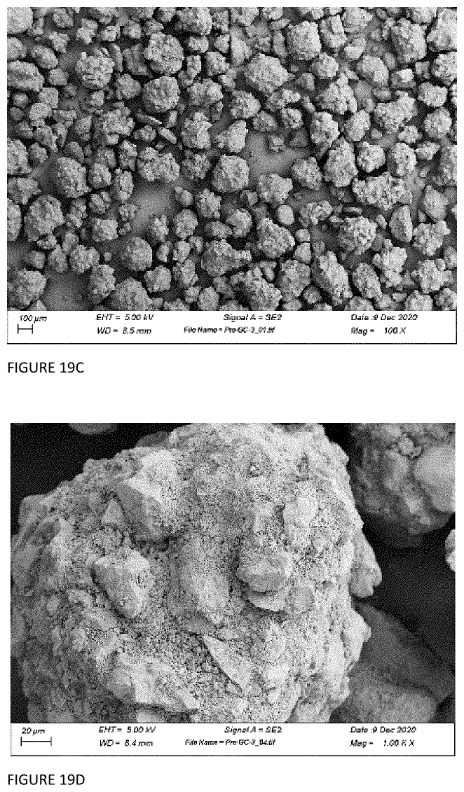

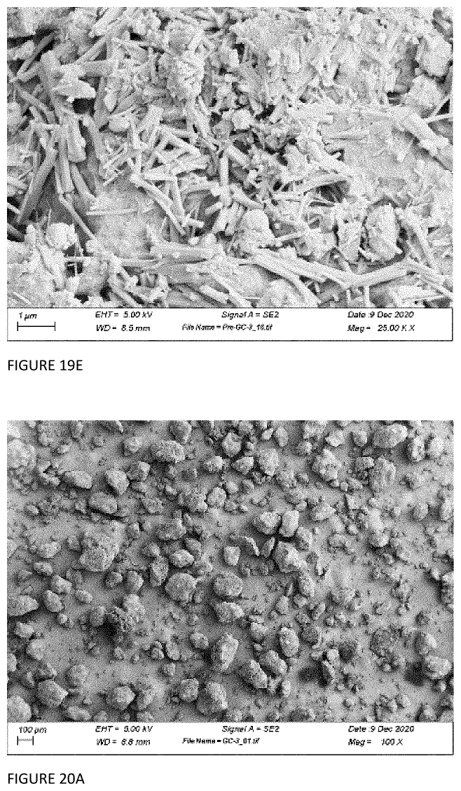

A typical fluidized bed is characterized by the solid particle characteristics, the superficial gas velocity (volumetric flow divided by cross-sectional area), and the H/D (height to diameter) ratio. Each particle size and density with respect to the gas will have different fluidization characteristics, typically classified by the Geldart system. Solidia Cement™ falls within the Geldart group A range, with the fine fraction falling within group C. The gas velocity must be within the range of fluidization of the particles. This range is defined by the characteristic Archimedes number of the particles, and the density difference with respect to the fluidization gas. Typical velocities range from 0.1 to 3 m/s. The H/D ratio determines the balance between solid throughput and pressure drop. An exemplary fluidized bed reactor is shown in FIG. 18. As shown, an exemplary fluidized bed reactor can include a cement and recycle fee 110, a produce draw off 120, a stack gas exhaust 130, a supplementary CO₂ feed 140 (if needed), a primary blower 150, a gas distributor 160, fluidized beds 171 and 172, freeboards 181 and 182, and a flue gas input 190.

As seen by the results in TABLES 1, 2 and 4, the type of CaCO₃ polymorph that is formed in the resulting SCM is depending on the method used to form the SCM. For example, calcite is the predominant polymorph formed in a slurry process. In comparison, vaterite is the primary CaCO₃ phase when the SCM is prepared using the semi-wet method described herein, and the calcite and aragonite phases are present in minor amounts. When the SCM is prepared by adding MgO with acetic acid (and optionally containing small amounts of citric acid, the CaCO₃ is present primarily in an aragonite phase, and the vaterite and calcite phases are present in small amounts. Thus, the SCM can contain all three polymorphs of CaCO₃ or can be tailored to have a specific primary polymorph by using a corresponding carbonation method described herein.

### Example 5—Granulation Method of Carbonation

A carbonation process generally requires wetting a carbonatable material prior to passes a CO₂-containing gas through the carbonatable material. When a carbonation process is carried out in an agitated (dynamic) chamber, the wet mixture forms a material that is deposited on the walls and cakes the chamber wall with a thick layer of the material. This caked material then starts undergoing the carbonation process (from it surface towards its bulk) and will get stronger in time. Cleaning of the walls of any such apparatus (generally having a capacity of 600 to 700 tons) presents quite an engineering challenge. Moreover, the wetted powder does not roll along the inner walls of such a mill. Even when the carbonatable material is conservatively wetted with water at a L/S ratio of 0.05 to 0.10, and then agitated/tumbled, it forms irregularly shaped and sized granules.

An inventive aspect of this application is the preparation of granules, which, when introduced to an agitated chamber, does not cake the walls of the chamber. A light milling step may be applied to the granules after carbonation to obtain carbonated SCM particulates having a diameter of about 70 μm to about 90 μm. The milling step may also eliminate the current water demand in concrete production.

Carbonation of such granules must be carried out when they are fresh and still have a significant percentage of their initial forming water. Once prepared, the granules lose their forming water within 7-10 days, and the moisture content of such granules can decrease to as low as 5%, especially if left exposed to ambient atmosphere. The granules may also form solvation/hydration products with the passage of time. Carbonation of such “aged” granules can be carried out by first performing a re-humidification step to increase the moisture content prior to carbonation.

In an exemplary embodiment, if granules having a particulate size of about 105 μm to about 250 μm are used in the carbonation process, the number of particulates used, to attain the same mass, per unit solvent volume of the same slurry (at constant L/S ratio in both cases) will be less compared to a carbonation process using a carbonatable material that has not been granulated, i.e., having a mean particulate size (d50) of about 13 μm to about 15 μm.

In an exemplary study, three different granulation sizes were examined—105 μm<granule diameter<250 μm (GC-1); 250 μm<granule diameter<297 μm (GC-2); and granule diameter<105 μm (GC-3).

### Example GC-1

20 grams of granulated carbonatable material, having a mean particle size of 105 μm<granule diameter<250 μm was added to a dynamic carbonation chamber. 250 ml of de-ionized (DI) water was added to the chamber such that an L/S ratio was 12.5. The granulated carbonatable material was stirred at 400 rpm for 5 hours at 75° C. A CO₂-containing gas was introduced at a rate of 6 LPM. The reaction product was dried overnight at 80° C. after filtering and washing with DI water. The pre-drying mass and post-drying mass were recorded. Other measurements/characterization carried out on the final product included: temperature profile recording during the reaction; microscope imaging; LECO™ C and S analysis of the initial and final samples; calcimeter testing on the carbonated samples; X-ray diffraction studies; thermogravimetric analysis; and recording of scanning electron microscope (SEM) images.

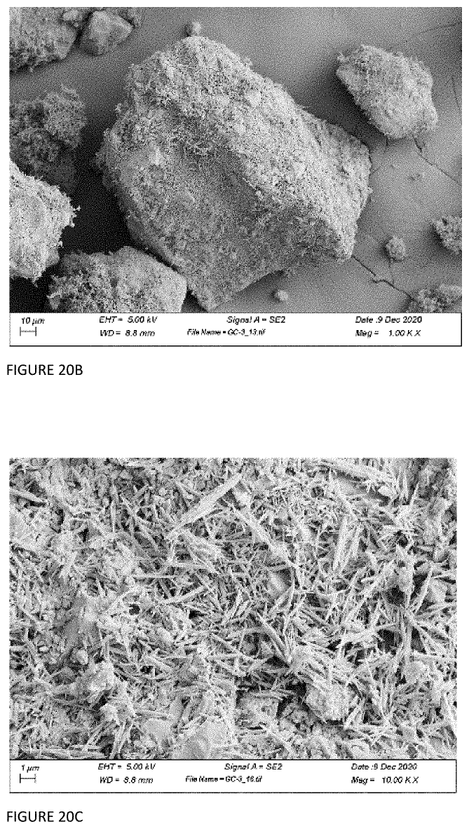

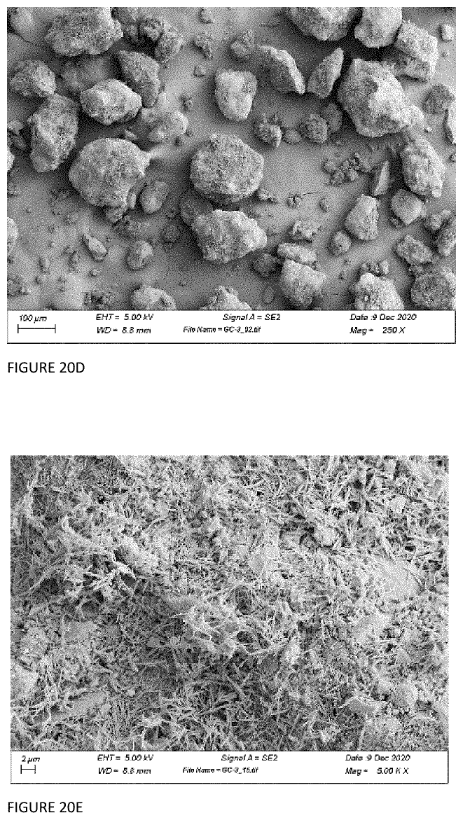

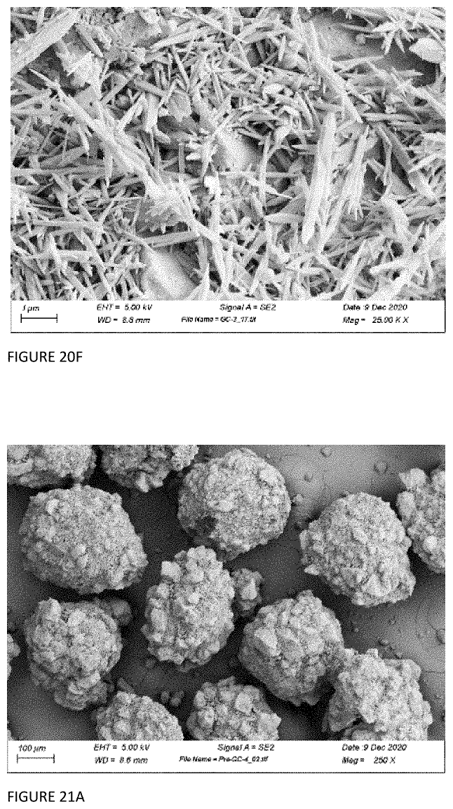

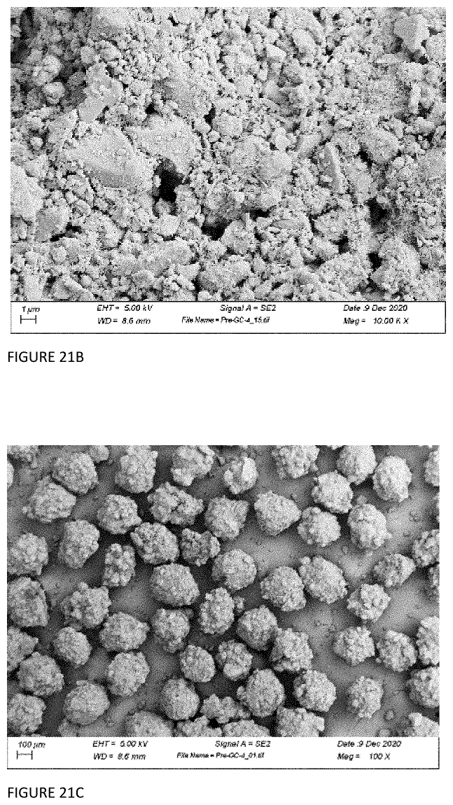

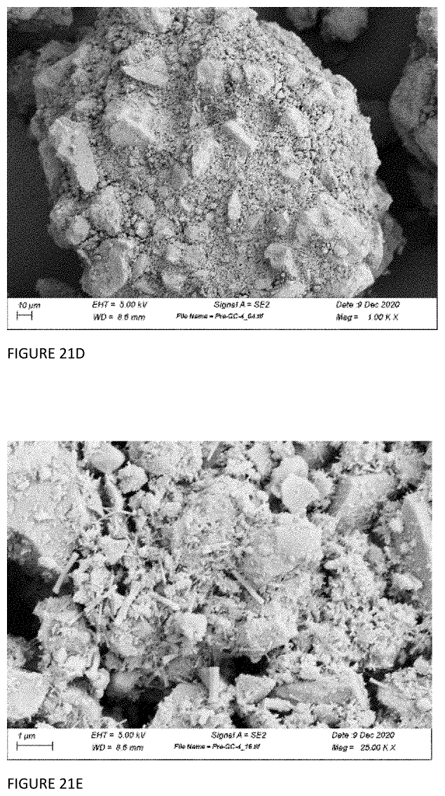

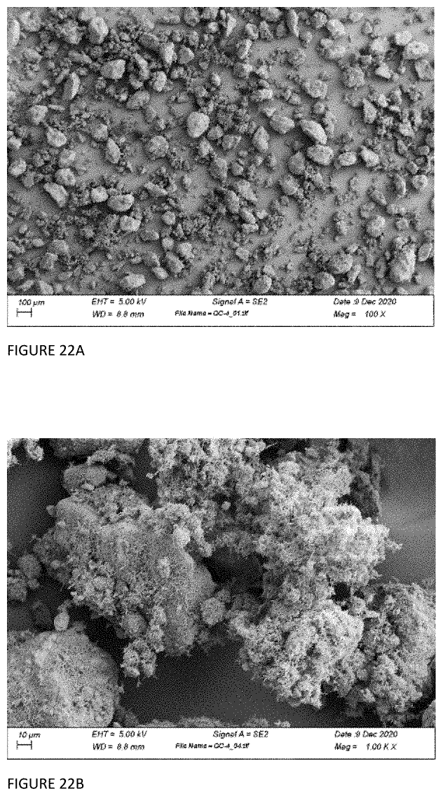

FIG. 20 includes SEM images of the GC-1 granules prior to carbonation, and the images were captured 34 days after the granules were produced. As shown in FIG. 20, SEM images were hydration rods were visible at the 25,000× image. A portion of the granules had pores less than 1 μm in diameter, making re-hydration difficult because water at 1 atm cannot penetrate these pores. Elemental analysis of the GC-1 material is shown in Table 5:

TABLE 5

| Material | Carbon Content | Sulphur Content |
|---|---|---|
| Pre-granulation | C: 0.38% (=1.39% CO₂) | S: 0.38% (=1.14% SO₄) |
| GC-1 granules, | C: 0.54% (=1.98% CO₂) | S: 0.37% (=1.11% SO₄) |
| pre-carbonation | | |
| GC-1 granules, | C: 3.3% (=12.10% CO₂) | S: 0.19% (=0.57% SO₄) |
| post carbonation | | |

As shown in Table 5, the amount of CO₂ captured after 5 h of stirred reaction 10.12% (=12.1−1.98), and the total amount of CO₂ uptake, from calcimeter readings, was 12.197%. Further, the various CaCO₃ phases obtained by this carbonation process are listed in Table 6:

TABLE 6

| | Initial | Carbonatable | |
|---|---|---|---|
| | Carbonatable | Material After | SCM after |
| | Material | Granulation | 5 hours of |
| Phases | (wt %) | (GC-1) | carbonation |
| Akermanite | 17.8% | 17.8% | 13.0% |
| Rankinite | 24.6% | 23.2% | 7.7% |
| Pseudo-wollastonite | 16.4% | 15.8% | 6.5% |
| Larnite | 3.5% | 1.2% | — |
| Calcite | 0.4% | — | 2.4% |
| Aragonite | — | — | 15.5% |
| Vaterite | — | — | 1.7 |
| SiO₂ | 3.3% | 3.5% | 3.2% |
| MgO | 0.5% | — | — |
| Amorphous | 33.5% | 38.5% | 50.0% |

### Example GC-2

20 grams of granulated carbonatable material, having a mean particle size of 250 μm <granule diameter <297 μm, measured using laser diffraction particle sizing, was added to a dynamic carbonation chamber. 250 ml of de-ionized (DI) water was added to the chamber such that an L/S ratio was 12.5. The granulated carbonatable material was stirred at 400 rpm for 5 hours at 60° C. A CO₂-containing gas was introduced at a rate of 3.4 LPM. The reaction product was dried overnight at 80° C. after filtering and washing with DI water. The pre-drying mass and post-drying mass were recorded. Other measurements/characterization carried out on the final product included: temperature profile recording during the reaction; microscope imaging; LECO C and S analysis of the initial and final samples; calcimeter testing on the carbonated samples; X-ray diffraction studies; thermogravimetric analysis; and recording of scanning electron microscope (SEM) images.

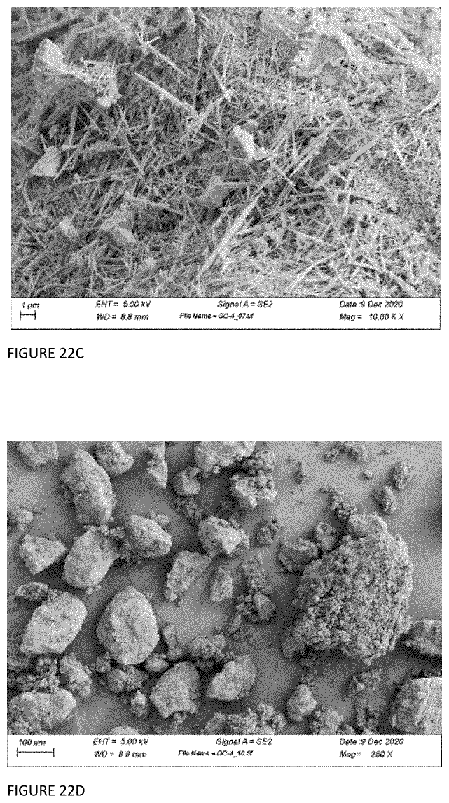

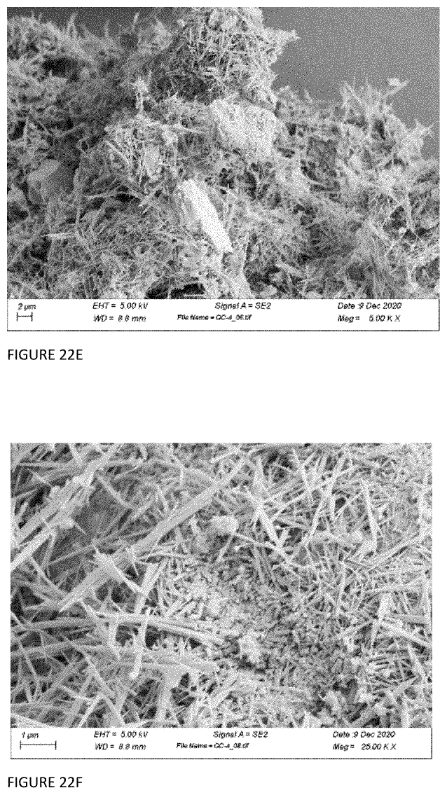

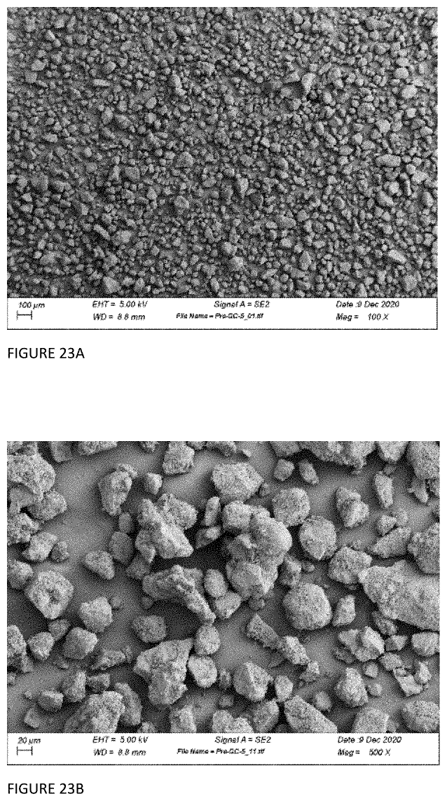

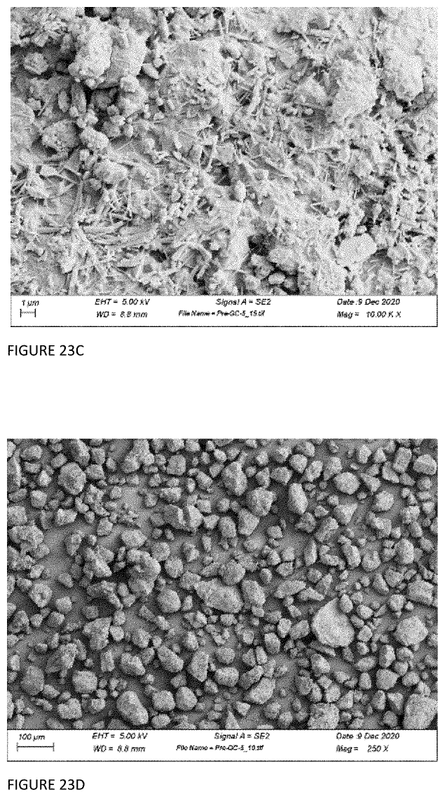

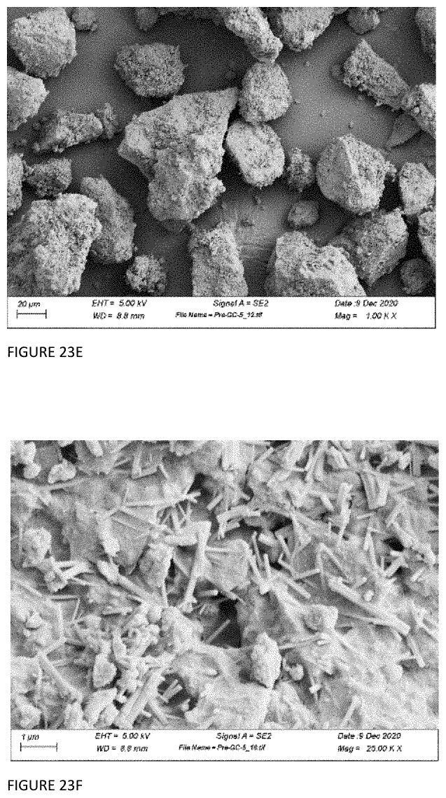

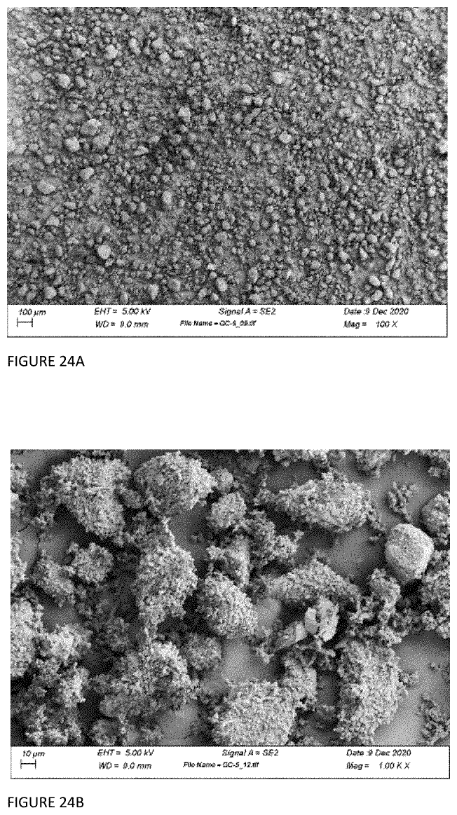

FIG. 22 includes SEM images of the GC-2 granules prior to carbonation, and the images were captured 34 days after the granules were produced. As shown in FIG. 22, SEM images were hydration rods were visible at the 25,000× image. A portion of the granules had pores less than 1 μm in diameter, making re-hydration difficult because water at 1 atm cannot penetrate these pores. Elemental analysis of the GC-2 material is shown in Table 7:

TABLE 7

| Material | Carbon Content | Sulphur Content |
|---|---|---|
| Pre-granulation | C: 0.38% (=1.39% CO₂) | S: 0.38% (=1.14% SO₄) |
| GC-2 granules, | C: 0.62% (=2.27% CO₂) | S: 0.35% (=1.05% SO₄) |
| pre-carbonation | | |
| GC-2 granules, | C: 4.0% (=14.66% CO₂) | S: 0.17% (=0.51% SO₄) |
| post carbonation | | |

As shown in Table 7, the amount of CO₂ captured after 5 h of stirred reaction 12.39% (=14.66−2.27), and the total amount of CO₂ uptake, from calcimeter readings, was 14.58%. Further, the various CaCO₃ phases obtained by this carbonation process are listed in Table 8:

TABLE 8

| | Initial | Carbonatable | |
|---|---|---|---|
| | Carbonatable | Material After | SCM after |
| | Material | Granulation | 5 hours of |
| Phases | (wt %) | (GC-2) | carbonation |
| Akermanite | 17.8% | 17.0% | 13.6% |
| Rankinite | 24.6% | 23.0% | 5.7% |
| Pseudo-wollastonite | 16.4% | 15.4% | 5.2% |
| Larnite | 3.5% | 1.5% | — |
| Calcite | 0.4% | 0.5% | 3.5% |
| Aragonite | — | — | 15.4% |
| Vaterite | — | — | 4.0 |
| SiO₂ | 3.3% | 3.4% | 2.9% |
| MgO | 0.5% | — | — |
| Amorphous | 33.5% | 39.2% | 49.7% |

### Example GC-3

20 grams of granulated carbonatable material, having a mean particle size of <105 μm was added to a dynamic carbonation chamber. 250 ml of de-ionized (DI) water was added to the chamber such that an L/S ratio was 12.5. The granulated carbonatable material was stirred at 400 rpm for 5 hours at 60° C. A CO₂-containing gas was introduced at a rate of 3.4 LPM. The reaction product was dried overnight at 80° C. after filtering and washing with DI water. The pre-drying mass and post-drying mass were recorded. Other measurements/characterization carried out on the final product included: temperature profile recording during the reaction; microscope imaging; LECO C and S analysis of the initial and final samples; calcimeter testing on the carbonated samples; X-ray diffraction studies; thermogravimetric analysis; and recording of scanning electron microscope (SEM) images.

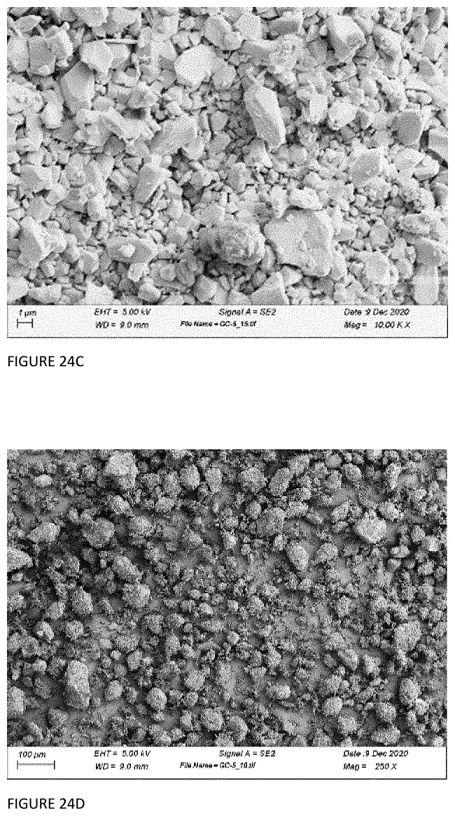

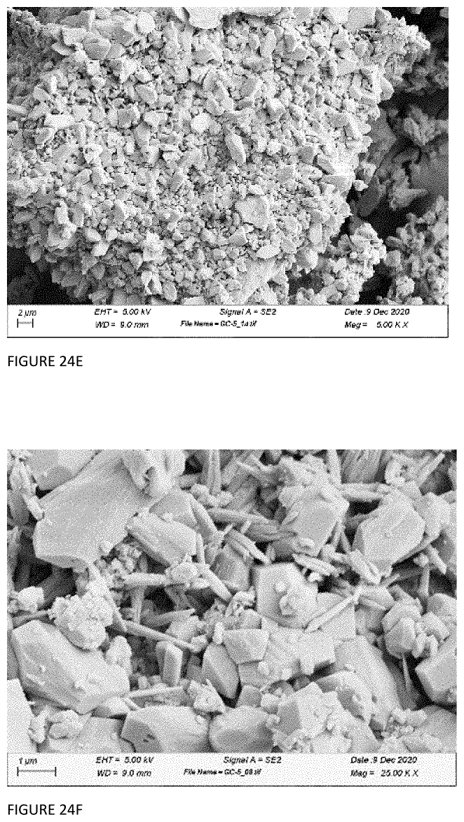

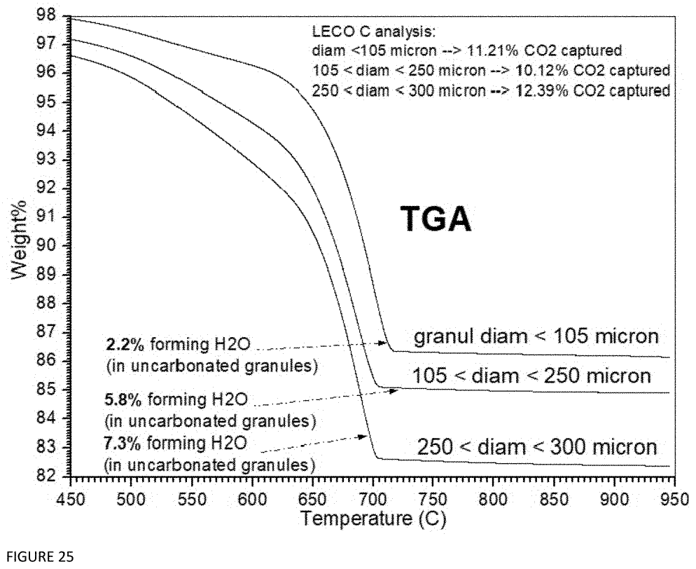

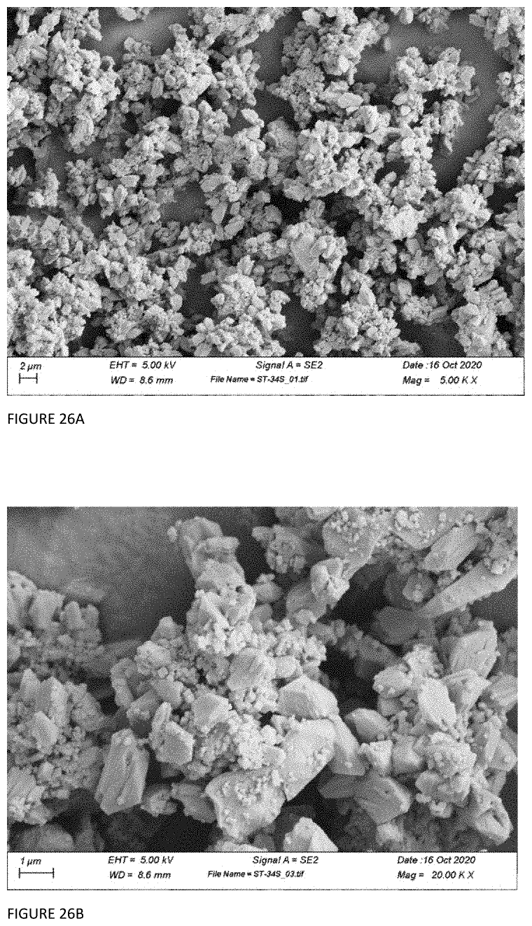

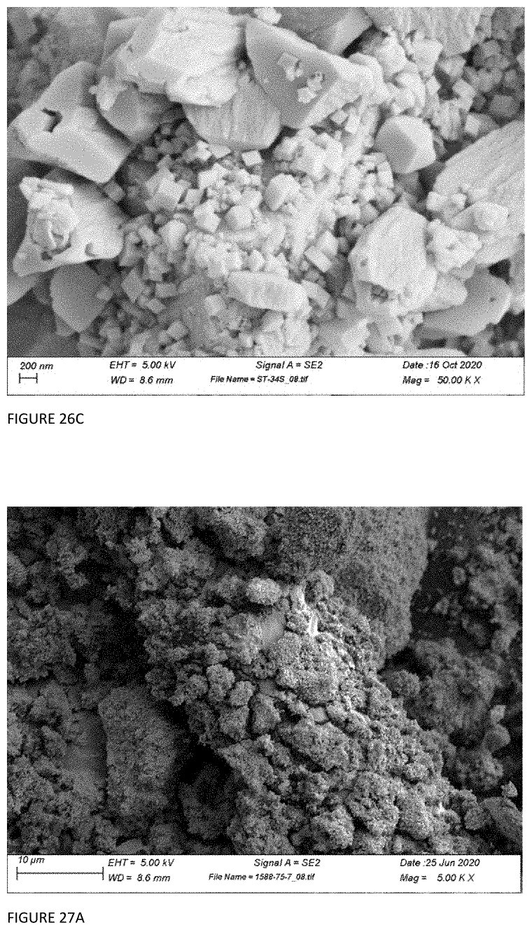

FIG. 24 includes SEM images of the GC-1 granules prior to carbonation, and the images were captured 34 days after the granules were produced. As shown in FIG. 24, SEM images were hydration rods were visible at the 25,000× image. A portion of the granules had pores less than 1 μm in diameter, making re-hydration difficult because water at 1 atm cannot penetrate these pores. Elemental analysis of the GC-3material is shown in Table 9:

TABLE 9

| Material | Carbon Content | Sulphur Content |
|---|---|---|
| Pre-granulation | C: 0.38% (=1.39% CO₂) | S: 0.38% (=1.14% SO₄) |
| GC-3 granules, | C: 0.34% (=1.25% CO₂) | S: 0.20% (=0.60% SO₄) |
| pre-carbonation | | |
| GC-3 granules, | C: 3.4% (=12.46% CO₂) | S: 0.11% (=0.33% SO₄) |
| post carbonation | | |

As shown in Table 9, the amount of CO₂ captured after 5 h of stirred reaction 11.21% (=12.46−1.25), and the total amount of CO₂ uptake, from calcimeter readings, was 10.61%. Further, the various CaCO₃ phases obtained by this carbonation process are listed in Table 10:

TABLE 10

| | Initial | Carbonatable | |
|---|---|---|---|
| | Carbonatable | Material After | SCM after |
| | Material | Granulation | 5 hours of |
| Phases | (wt %) | (GC-3) | carbonation |
| Akermanite | 17.8% | 13.8% | 11.9% |
| Rankinite | 24.6% | 19.2% | 7.6% |
| Pseudo-wollastonite | 16.4% | 12.1% | 4.7% |
| Larnite | 3.5% | 1.3% | — |
| Calcite | 0.4% | 0.3% | 17.2% |
| Aragonite | — | — | 2.8% |
| Vaterite | — | — | 1.2% |
| SiO₂ | 3.3% | 4.7% | 4.4% |
| MgO | 0.5% | — | — |
| Amorphous | 33.5% | 48.6% | 51.2% |

Symmetry of the CaCO₃ phases decreases in the order: calcite→vaterite→aragonite. A decrease in unit cell symmetry means that the polymorph with the lowest symmetry can form even at “non-stoichiometric” [Ca²⁺(aq)]/[CO₃²⁻(aq)] solution ratios. The unit cell volume increase in the order aragonite (227.11 Å³)→calcite (368.93 Å³)→vaterite (748.41 Å³). Thus, it is much easier to incorporate sulphate ions into the vaterite structure, which is why vaterite is observed in the XRD scans of the materials produced after carbonation. Aragonite, having the least symmetric crystal structure among the three polymorphs, can also allow the incorporation of sulphate ions, which is why both aragonite and vaterite are observed in the carbonated granules.

The principles of the present invention, as well as certain exemplary features and embodiments thereof, will now be described by reference to the following non-limiting examples.

As various changes could be made in the above methods and compositions without departing from the scope of the invention, it is intended that all matter contained in the above description shall be interpreted as illustrative and not in a limiting sense. Any numbers expressing quantities of ingredients, constituents, reaction conditions, and so forth used in the specification are to be interpreted as encompassing the exact numerical values identified herein, as well as being modified in all instances by the term “about.” Notwithstanding that the numerical ranges and parameters setting forth, the broad scope of the subject matter presented herein are approximations, the numerical values set forth are indicated as precisely as possible. Any numerical value, however, may inherently contain certain errors or inaccuracies as evident from the standard deviation found in their respective measurement techniques. None of the features recited herein should be interpreted as invoking 35 U.S.C. § 112, paragraph 6, unless the term “means” is explicitly used.

1. A method of preparing a carbonated supplementary cementitious material, the method comprising:
adding water to a carbonatable material to form a semi-wet mixture, wherein a moisture content of the semi-wet mixture is from about 0.1% to about 20% by mass based on the total mass of the semi-wet mixture;
agitating or stirring the semi-wet mixture for about 0.01 hour to 72 hours; and
carbonating the semi-wet mixture to obtain the carbonated cementitious material,
wherein carbonating the semi-wet mixture comprises a plurality of carbonation cycles, and wherein each of the plurality of carbonation cycles comprises flowing a gas comprising carbon dioxide into the semi-wet mixture and maintaining a temperature of about 1° C. to about 99° C.

2. The method of claim 1, wherein the moisture content of the semi-wet mixture is from about 5% to about 20%.

3. The method of claim 1, wherein the semi-wet mixture is agitated and/or stirred for about 5 hours to about 15 hours.

4. The method of claim 1, further comprising drying the carbonated supplementary cementitious material for about 6 to about 24 hours at a temperature of about 60° C. to about 120° C.

5. The method of claim 1, wherein the gas comprises about 5% to about 100% carbon dioxide, by volume.

6. The method of claim 1, further comprising spreading out the semi-wet mixture in a layer having a thickness of 1 inch or less prior to exposing the semi-wet mixture to a carbonation cycle.

7. The method of claim 1, further comprising de-agglomerating the semi-wet mixture, which can be carried out subsequent to or simultaneously with any one of the agitating, stirring and carbonating steps.

8. The method of claim 1, further comprising re-wetting and agitating or stirring the semi-wet mixture after each of the plurality of carbonation cycles.

9. The method of claim 1, further comprising a plurality of milling cycles of the carbonated supplementary cementitious material,
wherein the plurality of milling cycles are carried out concurrently with the plurality of carbonation cycles or the plurality of milling cycles and the plurality of carbonation cycles are carried out sequentially.

10. The method of claim 9, wherein each of the plurality of milling cycles is carried out for about 5 minutes to about 180 minutes.

11. The method of claim 9, wherein a mean particle size (d50) of the carbonated supplementary cementitious cement after completion of the plurality of milling cycles is from about 5 μm to about 25 μm.

12. The method of claim 9, wherein the plurality of milling cycles is are carried out in a ball mill, a vertical roller mill, a belt roller mill, a granulator, a hammer mill, a milling roller, a peeling roller mill, an air-swept roller mill, or a combination thereof.

13. The method of claim 1, further comprising moistening the gas comprising carbon dioxide prior to feeding the gas during the plurality of carbonation cycles, wherein moistening the gas comprises bubbling the gas through hot water.

14. The method of claim 1, wherein a flow rate of the gas comprising carbon dioxide is from about 3 L/min/Kg to about 6 L/min/Kg.

15. The method of claim 1, wherein the flowing the gas comprising carbon dioxide in the plurality of carbonation cycles is carried out for about 0.5 hours to about 24 hours.

16. The method of claim 1, wherein the carbonatable material includes at least one synthetic formulation having the general formula MₐMe_{b}O_{c}, MₐMe_{b}(OH)_{d}, MₐMe_{b}O_{c}(OH)_{d} or MₐMe_{b}O_{c} (OH)_{d}•(H₂O)ₑ, wherein M is at least one metal that can react to form a carbonate and Me is at least one element that can form an oxide during the carbonation reaction.

17. The method of claim 16, wherein M is calcium and/or magnesium.

18. The method of claim 16, wherein Me is silicon, titanium, aluminum, phosphorus, vanadium, tungsten, molybdenum, gallium, manganese, zirconium, germanium, copper, niobium, cobalt, lead, iron, indium, arsenic, sulfur and/or tantalum.

19. The method of claim 18, wherein Me is silicon.

20. The method of claim 16, wherein a ratio of a:b is about 2.5:1 to about 0.167:1, c is 3 or greater, d is 1 or greater, e is 0 or greater.

21. The method of claim 16, wherein the carbonatable material comprises calcium silicate having a molar ratio of elemental Ca to elemental Si of about 0.8 to about 1.2.

22. The method of claim 21, wherein the carbonatable material comprises a blend of discrete, crystalline calcium silicate phases, selected from one or more of CS (wollastonite or pseudowollastonite), C₃S₂ (rankinite) and C₂S (belite or larnite or bredigite), at about 30% or more by mass of the total phases, and about 30% or less of metal oxides of Al, Fe and Mg by total oxide mass.

23. The method of claim 19, wherein the carbonatable material further comprises an amorphous calcium silicate phase.

24. A method for forming cement or concrete, the method comprising:
forming a carbonated supplementary cementitious material according to the method of claim 1;
combining the carbonated supplementary cementitious material with a hydraulic cement composition to form a mixture, wherein the mixture comprises about 1% to about 99%, by mass, of the carbonated supplementary cementitious material, based on the total mass of solids in the mixture; and
reacting the mixture with water to form the cement or concrete.

25. The method of claim 24, wherein the mixture comprises about 20% to about 35% of the carbonated supplementary cementitious material by mass, based on the total mass of solids in the mixture.

26. The method of claim 24, wherein the hydraulic cement comprises one or more of ordinary Portland cement (OPC), calcium sulfoaluminate cement (CSA), belitic cement, or other calcium based hydraulic material.

27.-104. (canceled)
